(19) United States
(12) Patent Application Publication
(10) Pub. No.: US 2026/0368933 A1
(43) Pub. Date: Nov. 19, 2026

(54) METHODS AND SYSTEMS FOR ASSESSING THE IMAGING PERFORMANCE OF A LINE SCAN CAMERA USING A TEST TARGET

(71) Applicant: UNITED STATES POSTAL SERVICE, Washington, DC (US)

(72) Inventors: Kurt HECHT, Rydal, PA (US); Vuong Van NGUYEN, Clifton, VA (US); Todd Edwin CORDRAY, Carrollton, TX (US); Edward HOUSTON, Manassas, VA (US)

(21) Appl. No.: 19/678,799

(22) Filed: May 15, 2026

Related U.S. Application Data
(60) Provisional application No. 63/807,033, filed on May 16, 2025.

(51) Int. Cl. G06T 7/80; G06T 7/90; G08B 21/18

(52) U.S. Cl. CPC G06T 7/80; G06T 7/90; G08B 21/182; G06T 2207/10016; G06T 2207/10024; G06T 2207/30208

(57) ABSTRACT

Methods, systems, and testing targets for assessing the image quality performance of a line scan camera. Examples include imaging, with the line scan camera, a test face of a test target moving relative to the line scan camera in a transport direction, and based on the image data from the camera, determining one or more image quality attributes, which may include one or more of: a global lines-per-inch (LPI) value, one or more segmented LPI values, a dots-per-inch (DPI) value, one or more localized DPI values, a multi-axis spatial frequency response, including motion blur impact, a signal-to-noise ratio, camera alignment to target related distortion and balance, and a lighting uniformity value.

### CROSS REFERENCE TO RELATED APPLICATIONS

This application claims the benefit of U.S. Provisional Application No. 63/807,033 filed May 16, 2025, which is currently pending, the disclosure of which is hereby incorporated by reference herein in its entirety.

### TECHNICAL FIELD

The present disclosure relates generally to line scan cameras, and more particularly, to methods and devices for assessing the imaging performance of a line scan camera using a test target.

### BACKGROUND

Line scan cameras and area cameras are used in various imaging applications. Area cameras are versatile imaging devices designed to capture detailed visual information over a specific spatial region. Area cameras are equipped with sensors that can capture and process a wide range of visual data simultaneously, which makes them particularly useful in applications where a broad view is needed, such as in surveillance, industrial inspections, and scientific research. Since area cameras can capture a complete image in a single frame this makes them suitable for applications where a static or slow-moving subject needs to be imaged in its entirety, such as in photography or traditional video recording.

While area cameras are versatile and can handle a variety of scenes, line scan cameras are a more specialized or niche tool. Line scan cameras capture images one line at a time, making them useful for continuous or high-speed inspection of moving objects moving past the line scan camera, such as in manufacturing, automated mail/package sorting, or web inspection.

While there is an abundance of tools for assessing imaging performance of area cameras, due to the niche nature of line scan cameras, evaluation techniques, devices, and test targets that focus on the key image quality attributes needed to properly evaluate line scan camera performance and line scan camera conditions are lacking.

Accordingly, it may be desirable to provide new methods and devices for assessing the imaging performance of a line scan camera, as well as novel test targets for use with the methods and devices.

### SUMMARY

The present disclosure provides a method and a testing target for assessing the image quality performance of a line scan camera. The method may include motion-synchronous imaging, with the line scan camera, a test face of a test target moving relative to the line scan camera in a transport direction and based on the image data from the camera, determining one or more image quality attributes.

In some embodiments, the method may include imaging a test face of a test target moving relative to the line scan camera in a transport direction, where imaging includes capturing multiple scan lines of the test face perpendicular to the transport direction. Based on the image data from the multiple scan lines of the test face, determining one or more image quality attributes.

In some embodiments, the method may include determining a global lines-per-inch (LPI) value between a first LPI test marker in a leading end portion of the test face and a second LPI test marker in the trailing end portion of the test face. In some embodiments, the method may include determining a first segmented LPI value between the first LPI test marker and a third LPI test marker positioned between the first LPI test marker and the second LPI test marker, determining a second segmented LPI value between the second LPI test marker and a fourth LPI test marker positioned between the third LPI test marker and the second LPI test marker, and determining a third segmented LPI value between the third LPI test marker and a second LPI test marker.

In some embodiments, the method may include determining a maximum difference between the global LPI, first segmented LPI value, second segmented LPI value, and third segmented LPI values. In some embodiments, the method may include determining a difference between the global LPI value and a target global LPI value.

In some embodiments, the method may include providing an alarm indicator if the difference between the global LPI value and a target global LPI value exceeds a global LPI differential threshold value.

In some embodiments, the method may include determining a maximum LPI difference between the global LPI, the first segmented LPI value, the second segmented LPI value, and the third segmented LPI value. In some embodiments, the method may include providing an alarm indicator if the maximum LPI difference exceeds a segmented LPI differential threshold value.

In some embodiments, the method may include determining a global dots-per-inch (DPI) value between a first DPI test marker in the top end portion and a second DPI test marker in the bottom end portion. In some embodiments, the method may include determining a horizontal distortion value defined as the ratio between the global LPI value and the global DPI value. In some embodiments, the method may include providing an alarm indicator if the horizontal distortion value exceeds a horizontal distortion threshold value.

In some embodiments, the method may include determining a first localized DPI value of a first localized DPI test marker in the top end portion, determining a second localized DPI value of a second localized DPI test marker in the bottom end portion, and, determining a third localized DPI value of an intermediate localized DPI test marker located between the first localized DPI test marker and the second localized DPI test marker.

In some embodiments, the method may include determining a DPI end balance value defined as a ratio of the first localized DPI value to the second localized DPI value. In some embodiments, the method may include determining a vertical distortion value defined as a ratio of the average of the first localized DPI and the second localized DPI to the third localized DPI. In some embodiments, the method may include providing an alarm indicator if the DPI end balance value is less than a DPI end balance threshold value. In some embodiments, the method may include providing an alarm indicator if the vertical distortion value exceeds a vertical distortion threshold value.

In some embodiments, the method may include a projected lighting uniformity analysis. For example, in some embodiments, the method may include determining a first average grayscale value of a first set pixel location across multiple scan lines in a uniformity test white area, a second average grayscale value of a second set pixel location across the multiple scan lines, and a third average grayscale value of a third set pixel location across the multiple scan lines. The method may further include determining a uniformity value indicative of the difference between any two of the average grayscale values and providing an alarm indicator if the uniformity value is less than a uniformity threshold value.

In some embodiments, the method may include a dead pixel analysis. In some embodiments, the method may include determining a grayscale value of a first pixel of a scan line in a uniformity test white area, determining a grayscale value of a second pixel of the scan line, and determining a grayscale value of a third pixel of the scan line, where the first, the second, and the third pixels are contiguous. In some embodiments, the method may further include determining the difference between an average grayscale value of the first and third pixels and the grayscale value of the second pixel. In some embodiments, the method may further include providing an alarm indicator if the difference exceeds dead pixel threshold value.

In some embodiments, the method may include determining one or more vertical spatial frequency responses at the half sampling interval (i.e., 0.5 cycles per pixel). In some embodiments, the method may include determining a first vertical spatial frequency response at 0.5 cycles per pixel based on a first SFR test marker in the top end portion, a second vertical SFR at 0.5 cycles per pixel based on a second SFR test marker in the bottom end portion, and a third SFR at 0.5 cycles per pixel based on a third SFR test marker in a central portion of the test face.

In some embodiments, the method may include determining one or more horizontal spatial frequency responses at the half sampling interval (i.e., 0.5 cycles per pixel). In some embodiments, the method may include determining a first horizontal SFR at 0.5 cycles per pixel based on the first SFR test marker, a second horizontal SFR at 0.5 cycles per pixel based on the second SFR test marker, and a third horizontal SFR at 0.5 cycles per pixel based on the third SFR test marker.

In some embodiments, the method may include determining a first vertical SFR difference between the first vertical SFR at 0.5 cycles per pixel and the second vertical SFR at 0.5 cycles per pixel, determining a second vertical SFR difference between the third vertical SFR at 0.5 cycles per pixel and one of the first vertical SFR at 0.5 cycles per pixel, the second vertical SFR at 0.5 cycles per pixel or the average of the first and second vertical SFR at 0.5 cycles per pixel, and providing an alarm indicator if the first vertical SFR difference or the second vertical SFR difference exceeds a vertical SFR difference threshold value.

In some embodiments, the method may include determining a first horizontal SFR difference between the first horizontal SFR at 0.5 cycles per pixel and the second horizontal SFR at 0.5 cycles per pixel and determining a second horizontal SFR difference between the third horizontal SFR at 0.5 cycles per pixel and one of the first horizontal SFR at 0.5 cycles per pixel, the second horizontal SFR at 0.5 cycles per pixel or the average of the first and second horizontal SFR at 0.5 cycles per pixel, and providing an alarm indicator if the first horizontal SFR difference or the second horizontal SFR difference exceeds a horizontal SFR difference threshold value.

In some embodiments, the method may include determining one or more vertical cycles-per-pixel (CPP) intervals at 50% SFR (SFR-50). In some embodiments, the method may include determining a first vertical cycles-per-pixel (CPP) interval at 50% SFR (SFR-50) based on a first SFR test marker, a second vertical CPP at SFR-50 based on a second SFR test marker, and a third vertical CPP at SFR-50 based on a third SFR test marker.

In some embodiments, the method may include determining one or more horizontal cycles-per-pixel (CPP) intervals at 50% SFR (SFR-50). In some embodiments, the method may include determining a first horizontal CPP at SFR-50 based on a first SFR test marker, a second horizontal CPP at SFR-50 based on a second SFR test marker, and a third horizontal CPP at SFR-50 based on a third SFR test marker.

In some embodiments, the method may include providing an alarm indicator if any of the first vertical CPP at SFR-50, the second vertical CPP at SFR-50, the third vertical CPP at SFR-50, the first horizontal CPP at SFR-50, the second horizontal CPP at SFR-50, and the third horizontal CPP at SFR-50 exceeds an CPP at SFR-50 threshold value.

In some embodiments, the method may include determining one or more signal-to-noise ratio (SNR) result(s) for a plurality of pixels. In some embodiments, the method may include determining a first signal-to-noise ratio (SNR) result for a plurality of pixels in a first SNR white test area on the test face, determining a second SNR for a plurality of pixels in a second SNR white test area on the test face, and determining a third SNR for a plurality of pixels in a third SNR white test area. In some embodiments, the method may include determining a maximum difference between the first SNR, the second SNR, and the third SNR and providing an alarm indicator if maximum difference exceeds a SNR threshold value.

In some embodiments, the method may include collecting and processing image data during live operational runs and determining one or more operational performance metrics indicative of the performance during the live runs. In some embodiments, the method may include providing an operational calibration by correlating the one or more operational performance metrics with one or more performance attributes based on image data from the multiple scan lines of the test face.

The present disclosure provides a test target for assessing image quality of a line scan camera. The test target may be configured to be synchronously moved relative to the line scan camera in a transport direction while being imaged by the line scan camera. In some embodiments, the test target may include a planar test face structurally configured to extend perpendicular to an optical axis of the line scan camera during testing. In some embodiments, the test face may have a leading end portion, a trailing end portion opposite the leading end portion, a top end portion extending between the leading end portion and the trailing end portion, a bottom end portion opposite the top end portion and extending between the leading end portion and the trailing end portion.

In some embodiments, the test target may include a plurality of test portions located on the planar test face.

In some embodiments, the test target may include a lines-per-inch (LPI) test portion having a series of LPI test markers evenly spaced apart in a line extending in the transport direction. In some embodiments, the series of LPI test markers may include a first LPI test marker in the leading end portion, a second LPI test marker in the trailing end portion, and one or more intermediate LPI test markers between the first LPI test marker and the second LPI test marker.

In some embodiments, the test target may include a dots-per-inch (DPI) test portion having a first DPI test marker in the top end portion and a second DPI test marker in the bottom end portion spaced apart from the first DPI test marker in a vertical direction that is perpendicular to the transport direction.

In some embodiments, the test target may include a localized DPI test portion having a first localized DPI test marker in the top end portion, a second localized DPI test marker in the bottom end portion, and an intermediate localized DPI test marker evenly spaced apart from both the first localized DPI test marker and the second localized DPI test marker in the transport direction. In some embodiments, the localized DPI test marker may have a first height, the second localized DPI test marker may have a second height, and the intermediate localized DPI test marker may have a third height, where the first height, the second height, and the third height are equal.

In some embodiments, the test target may include a uniformity test portion having an uninterrupted white area, with uniform grayscale value, extending from the top end portion to the bottom end portion in the vertical direction and having a width of two or more pixels.

In some embodiments, the test target may include a spatial frequency response (SFR) test portion having a first SFR test marker in the top end portion, a second SFR test marker in the bottom end portion spaced apart from the first SFR test marker in the vertical direction, and a third SFR test marker evenly spaced apart from both the first and second SFR test markers in the vertical direction.

In some embodiments, the test target may include a signal-to-noise ratio (SNR) test portion having a first SNR white test area positioned in the top end portion, a second SNR white test area positioned in the bottom end portion, and a third SNR white test area positioned between the top end portion and the bottom end portion, wherein the first SNR white test area, the second SNR white test area, and the third SNR white test area may have the same grayscale value.

In some embodiments, the first LPI test marker, the second LPI test marker, and the third LPI test marker may being the top end portion. In some embodiments, the first LPI test marker, the second LPI test marker, and the third LPI test marker may be circular.

In some embodiments, the first DPI test marker and the second LPI test marker may be the same test marker. In some embodiments, each of the localized DPI test markers may include a slanted edge extending in the transport direction. In some embodiments, the slanted edge of each of the localized DPI test markers may be slanted at an angle relative to the transport direction in the range of 3-7 degrees.

In some embodiments, each of the first, the second, and the third SFR test markers may include a slanted horizontal edge and a slanted vertical edge.

In some embodiments, the first, the second, and the third SNR white test areas may be positioned at different locations relative to the transport direction.

In some embodiments, the test target may include an optical efficiency conversion factor (OECF) test portion having a plurality of OECF test markers each with a different grayscale value. In some embodiments, the plurality of OECF test markers may be positioned in an arrangement of decrementing grayscale values.

In some embodiments, the plurality of OECF markers may include 20 markers that decrement from a first grayscale value to a twentieth grayscale value in decrements of a grayscale value of 13.

In some embodiments, the arrangement of the plurality of OECF test targets may include a zig zag arrangement of decrementing grayscale value. In some embodiments, the plurality of OECF test markers may have an overall grayscale value range and each OEFC test marker in the lower half of the range may be arranged adjacent to an OEFC test marker in the upper half of the range.

In some embodiments, each OEFC test marker in the lower half of the range may be separated from the adjacent OEFC test marker in the upper half of the grayscale value range by a bar space transition. In some embodiments, the bar space transition may include a 0.02 inch thick bar in the lower half of the grayscale value range and a 0.02 inch thick space in the upper half of the grayscale value range.

In some embodiments, the test target may include mini-monochrome resolution test portion with location fiducial having orthogonally oriented slanted modulated bar/space pairs. In some embodiments, the test target may include a first slanted bar-space pattern extending in the traverse direction, a second slanted bar-space pattern extending in the transport direction, a third slanted bar-space pattern extending in the traverse direction, and a fourth slanted bar-space pattern extending in the transport direction. In some embodiments, the first and the second slanted bar-space patterns may have a first spacing and the third and fourth bar-space patterns may have a second spacing different than the first spacing. In some embodiments, the mini-monochrome resolution test portion with location fiducial may further include a black reference color area and a white reference color area.

In some embodiments, the test target may include a color test portion having a plurality of color test markers each with a different calibration color. In some embodiments, the plurality of color test may include a plurality of color test marker pairs. In some embodiments, the plurality of color test marker pairs may include three primary color-inverse color pairs and three half color pairs to the three primary color-inverse color pairs. In some embodiments, the three primary color-inverse color pairs may be arranged in an alternating pattern with the three half color pairs to the three primary color-inverse color pairs.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a schematic illustration of an example line scan camera system.

FIG. 2 is an example line scan camera test target.

FIG. 3 is an example lines-per-inch test portion of the test target of FIG. 2.

FIG. 4. is an example dots-per-inch test portion of the test target of FIG. 2

FIG. 5 is an example uniformity test portion and a signal-to-noise ratio test portion of the test target of FIG. 2.

FIG. 6 is an example mini-monochrome resolution test portion with location fiducial of the test target of FIG. 2.

FIG. 7 is an example spatial response frequency test portion of the test target of FIG. 2.

FIG. 8 is an example optical efficiency conversion factor test portion of the test target of FIG. 2.

FIG. 9 is the example optical efficiency conversion factor test portion of FIG. 8 highlighting a binarization checking portion.

FIG. 10 is an example reflectance response plot.

FIG. 11 is an example density response plot.

FIG. 12 is a block diagram of an example system level workflow for assessing the imaging performance of a line scan camera

### DETAILED DESCRIPTION

Reference will now be made in detail to presently preferred embodiments and methods of the present disclosure, which constitute the best modes of practicing the present disclosure presently known to the inventors. The figures are not necessarily to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” can comprise plural referents unless the context clearly indicates otherwise. For example, reference to a component in the singular is intended to comprise either one or a plurality of components.

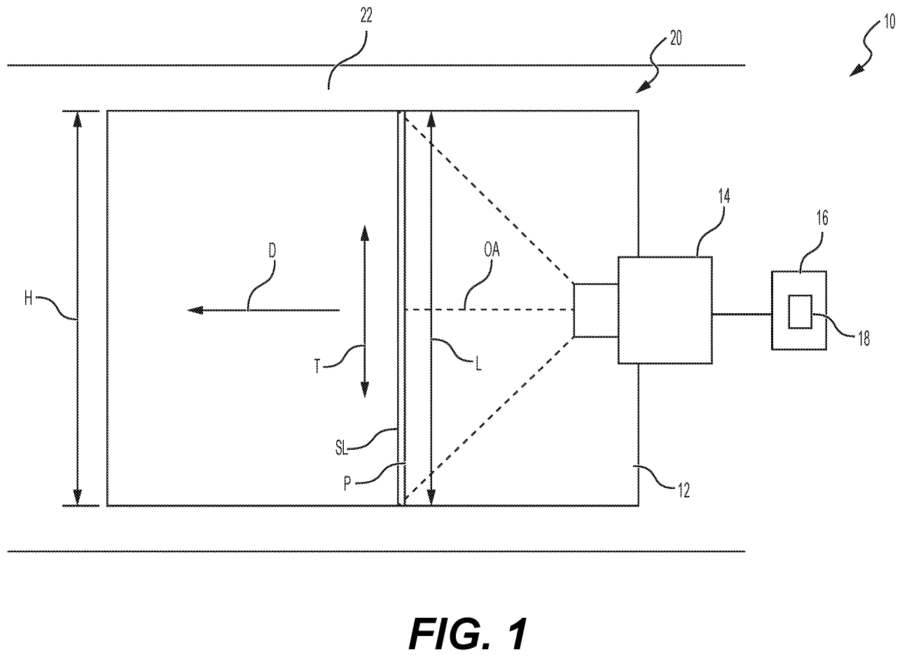

Referring to the example shown in FIG. 1, embodiments of the disclosure provide a line scan camera system 10 configured to image one or more objects 12 moving relative to the line scan camera system 10. In various implementations, the object 12 may be a mail piece, a package that is being sorted for delivery, a manufactured product, a test card as described herein, etc. The line scan camera system 10 may include a line scan camera 14 and a processor 16 configured to receive image data from the line scan camera 14. A memory 18 may be associated with (e.g., couple to) the processor 16. The memory 18 may include instructions executable by the processor 16, where the processor 16 is operable when executing the instructions to perform the processes, functions, and/or operations described herein, such as operations to analyze the image data from the line scan camera 14 to assess the imaging quality of the line scan camera 14. The memory 18 may also include preloaded data describing or representing the object 12, (such as a test target 100, described below) and/or the mover 20, and the memory 18 may also be used to store image data from the line scan camera 14 and test values and assessment results calculated or determined by the processor 16.

The line scan camera 14 may be any suitable line scan camera for the application for which the camera is being used (e.g., CCD or CMOS line scan cameras). The line scan camera 14 may have any suitable resolution (e.g., 2 k to 16 k) and any suitable sampling rate. The processor 16 may include a central processing unit, a graphics processing unit, a microprocessor, a controller, a microcontroller, a digital signal processor, a field-programmable gate array, an application-specific integrated circuit, and/or another type of processing component or components. The processor 16 may be implemented in hardware, firmware, or a combination of hardware and software. In some implementations, the processor 16 may include one or more processors capable of being programmed to perform the processes, functions, or operations described herein. The memory 18 may include a random-access memory, a read-only memory, and/or another type of memory (e.g., a flash memory, a magnetic memory, solid-state drive, and/or an optical memory).

As shown in the example of FIG. 1, the object 12 to be imaged by the line scan camera 14, and the object 12 and the line scan camera 14 may move relative to each other. In some embodiments, the line scan camera 14 may be stationary and the object 12 may move, for example, on a mail piece transport system, a conveyor belt, or the like. In other embodiments, the line scan camera 14 may move and the object 12 may be stationary. In the illustrated embodiment, the object 12 may be carried on a mover or conveyor 20 (e.g., conveyor belt) in a transport direction D. In various implementations, the motion relative to the object 12 and the camera 14 may be controlled and synchronized. In the description and drawings, the transport direction D may be illustrated and referred to as horizontal for ease of description.

In some embodiments, the line scan camera 14 may be mounted above the object 12 such that the line scan camera 14 aims downward toward the object 12. In some embodiments, the object 12 may have a dimension referred to as a height H, and the line scan camera 14 may be positioned such that the optical axis OA of the line scan camera 14 is centered with respect to the height H and is perpendicular to the plane of a surface 22 of the conveyor 20 and/or the top of the object 12 being imaged.

As shown in FIG. 1, in the illustrated embodiment, the line scan camera 14 captures image data along a scan line SL that extends in a transverse direction T that is perpendicular to the transport direction D. In this application, the transverse direction T may be illustrated and referred to as vertical for ease of description and illustration. The scan line SL may be described as a row of pixels P. Thus, in some implementations, the scan line SL may have a width of one pixel and a length L equal to the number of pixels in the scan line SL. The number of pixels P in the scan line SL of FIG. 1 is for illustrative purposes only. The actual size of the pixels in the scan line SL will be much smaller. For example, in some embodiments, the pixel size in the object plane may be in the range from 0.004 inches by 0.004 inches, plus or minus approximately 20 percent.

Two-dimensional images are acquired by the line scan camera 14 line-by-line by successive single-line scans while the object 12 moves horizontally in direction D past the scan line SL. Thus, to capture a complete image without gaps, the sampling rate of the line scan camera 14 is synchronized, typically with an incremental encoder, to the speed that the object 12 is moving and to the pixel size. Thus, for an embodiment of the system with a pixel size of 0.004 inches by 0.004 inches, the line scan camera 14 captures a partial image along the scan line SL of the moving object 12 for every 0.004 inches of travel of the object 12.

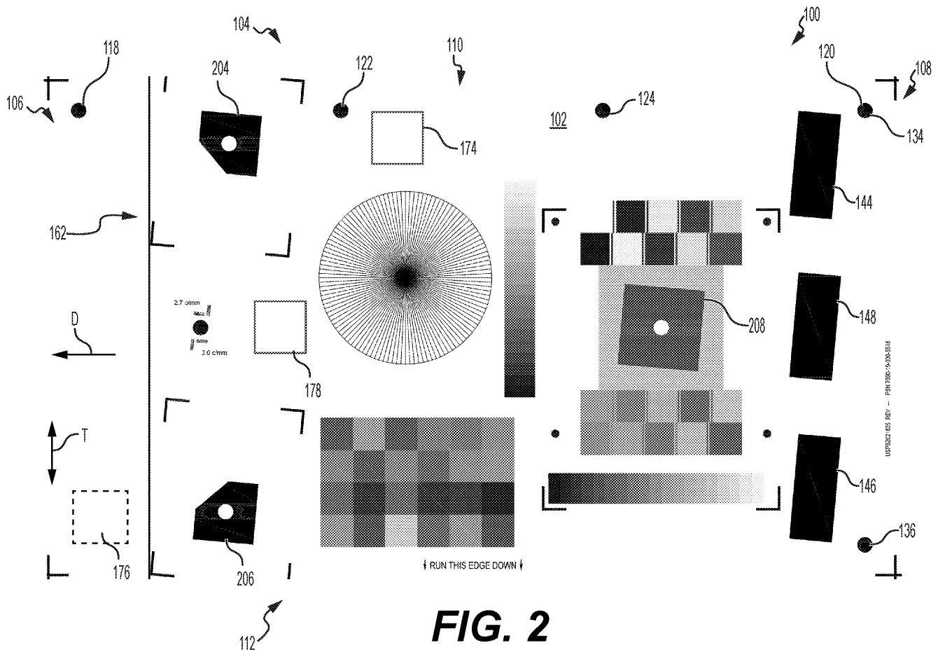

FIG. 2 illustrates an example line scan camera test target 100 (also referred to herein as a test card) configured to provide novel image data when imaged by the line scan camera 14 that, upon analysis, may effectively characterize the imaging performance of the line scan camera 14. In various implementations, the object 12 may be or include a piece of paper, a piece of cardstock, a piece of cardboard, a piece of plastic, a cardboard box, an envelope, or the like, that is or includes a line scan camera test target 100, which may, for example, be printed on the object 12 (e.g., on a card). The line scan camera test target/card 100 may be configured in a variety of ways. In some embodiments, the line scan camera test target 100 may include a test face 102 (e.g., a planar surface) having a plurality of test portions 104 (e.g., test zones, analysis regions, etc.) that are configured to produce, result in, or supply specialized technical image data when scanned by the line scan camera 14. The image data, when analyzed by a computer or processor 16, may allow for the determination of image quality attributes that may be used to assess the condition and imaging performance of the line scan camera 14.

The line scan camera test target 100 can be configured to include different test portions 104 for ascertaining different image quality attributes, and the test portions 104 may be specifically designed for assessing various performance abilities or conditions of a line scan camera. For example, the image quality attributes, may include, but are not limited to, lines-per-inch, dots-per-inch, spatial frequency response, vertical distortion, horizontal distortion, signal-to-noise ratio, optical efficiency conversion factor, uniformity, and/or vertical and horizontal end balance, among other quality attributes.

The test face 102 may be structurally configured to extend perpendicular to the optical axis OA of the line scan camera 14 during testing. In some embodiments, as shown in FIG. 2, the test face 102 may include a leading end portion 106, a trailing end portion 108 opposite the leading end portion 106, a top end portion 110 extending between the leading end portion 106 and the trailing end portion 108, and a bottom end portion 112 that is opposite the top end portion 110 and extending between the leading end portion 106 and the trailing end portion 108. As noted, in some examples, the line scan camera test target 100 may be implemented as a sheet of cardstock, cardboard, or plastic, and the test face 102 may be printed on the sheet of material.

Referring to FIGS. 2 and 3, in some embodiments, the line scan camera test target 100 may include a lines-per-inch (LPI) test portion 114. The LPI test portion 114 may be configured in a variety of ways. In some embodiments, the LPI test portion 114 may include a series of LPI test markers 116. The LPI test markers 116 may be configured in a variety of ways, including, but not limited to, shape, size, location, color, orientation, and arrangement.

In some embodiments, a series of LPI test markers 116 may be evenly spaced apart in a line extending in the transport direction D. In some embodiments, the series of LPI test markers 116 may extend in a line in the top end portion 110. In some embodiments, the series of LPI test markers 116 may include a first LPI test marker 118 in the leading end portion 106, a second LPI test marker 120 in the trailing end portion 108, a third LPI test marker 122 between the first LPI test marker 118 and the second LPI test marker 120, and a fourth LPI test marker 124 between the third LPI test marker 122 and the second LPI test marker 120. In various embodiments, the spacing (e.g., measurement in inches) between the LPI test markers may be predetermined and known when the line scan camera test target 100 is produced, and the spacing information may be accessible to the processor 16.

In some embodiments, the processor 16 may be operable to execute instructions to calculate or determine the LPI between the series of LPI test markers 116 based on the image data. In the illustrated example, each of the first, second, third, and fourth LPI test markers 118, 120, 122, 124 may be circular, black dot and the processor 16 may be configured to find or identify the center of each of the LPI test markers 118, 120, 122, 124 and calculate or determine the LPI between the centers of the LPI test markers 118, 120, 122, 124. For example, in some implementations, the processor 16 may analyze stored image data to identify a first scan line (e.g., a SL of FIG. 1) that is the center of the test marker 118 and to identify a second scan line that is the center of the test marker 122, and then count the number of scan lines between the two identified center scan lines. The processor 16 may then divide the counted number of scan lines by the number of inches between the center of the test marker 118 and the center of the test marker 122 to calculate the lines per inch. In some such implementations, the number of inches between the centers of 118 and 122 may be predetermined and accessible to the processor 16 as part of the stored data describing the line scan camera test target 100.

In various embodiments, the processor 16 may determine a global LPI value by determining the LPI between the first LPI test marker 118 and the second LPI test marker 120, as indicated by arrow GLPI in FIG. 3. Since the first LPI test marker 118 is positioned in the leading end portion 106 and the second LPI test marker 120 is positioned in the trailing end portion 108, the global LPI value is representative of the average LPI for the entire test target 100.

In some embodiments, the LPI determination may be segmented to help identify any non-linearities in the transport motion. For example, the third LPI test marker 122 and the fourth LPI test marker 124 may be used to segment the LPI determination. In some embodiments, the processor 16 may determine a first segmented LPI value between the first LPI test marker and a third LPI test marker, a second segmented LPI value between the second LPI test marker and a fourth LPI test marker, and a third segmented LPI value between the third LPI test marker and a second LPI test marker, as indicated by arrows LPI-1, LPI-2, and LPI-3 in FIG. 3.

In some embodiments, the processor 16 may be configured to compare the global LPI to a target global LPI value. Differences between the global LPI to a target global LPI value (e.g., greater than 1% difference) may be indicative of, for example, transport-related issues. In some embodiments, the target global LPI may be, for example, 256 LPI (lines per inch). In some embodiments, the processor 16 may be configured to compare the GLPI, LPI-1, LPI-2, and LPI-3 to each other to determine a maximum difference between the global LPI, first segmented LPI value, second segmented LPI value, and third segmented LPI values. If the transport velocity is constant, as desired, the global LPI, the first segmented LPI value, the second segmented LPI value, and the third segmented LPI value will be the same or similar. Thus, the maximum difference exceeding a maximum LPI differential threshold value (e.g., greater than 1% difference) may be indicative of, for example, transport related issues (e.g. acceleration or deceleration during the movement of the test target 100) (see table 1 regarding troubleshooting). In some embodiments, the processor 16 may be configured to provide an alarm indicator if the maximum LPI difference exceeds a segmented LPI differential threshold value (e.g., greater than 1% difference) and/or if the difference between the global LPI value and a target global LPI value exceeds a global LPI differential threshold value (e.g., greater than 1% difference). The alarm indicator may be any suitable indication (e.g., an audio or visual indication) that the data analysis has identified an irregularity. For example, the alarm indicator may be a highlighted cell on a spreadsheet, an alarm message/warning sent to a user interface, or other suitable alarm indication. In some embodiments, as described further below, the processor 16 may modify, control, or correct the transport velocity, for example, when triggered by the detection of an alarm indication.

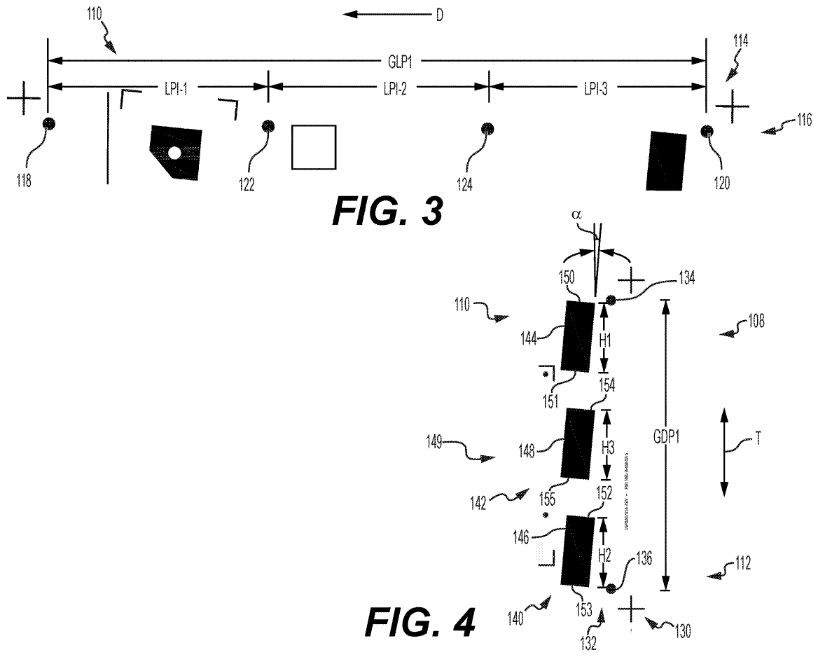

Referring to FIGS. 2 and 4, in some embodiments, the line scan camera test target 100 may include a dots-per-inch (DPI) test portion 130. The DPI test portion 130 may be configured in a variety of ways. In some embodiments, the DPI test portion 130 may include two or more DPI test markers 132. The DPI test markers 132 may be configured in a variety of ways, including, but not limited to, shape, size, location, color, orientation, and arrangement.

In some embodiments, the DPI test markers 132 may be spaced apart in a line extending in the vertical direction T (i.e., perpendicular to the transport direction D). In some embodiments, the DPI test portion 130 may include a first DPI test marker 134 in the top end portion 110 and a second DPI test marker 136 in the bottom end portion 112 spaced apart from the first DPI test marker 134. The spacing may be predetermined and known and stored based on the production specifications of the line scan camera test target 100. In some embodiments, the first DPI test marker 134 may be the same test marker as the second LPI test marker 120. In other embodiments, however, a separate test marker may be used for the first DPI test marker 120.

In some embodiments, the processor 16 may be operable to execute instructions to determine the global DPI between the first DPI test marker 134 and the second DPI test marker 136 based on the image data. In the illustrated example, each of the first and second DPI test markers 134, 136 may be a circular, black dot and the processor 16 may be configured to find the center of each of the DPI test markers 134, 136. For example, in some implementations, the processor 16 may analyze stored image data to identify a first pixel or dot (e.g., P in FIG. 1) that is the center of the test marker 134 and to identify a second pixel that is the center of the test marker 136 and then count the number of pixels between the two identified center pixels. The processor 16 may then divide the counted number of pixels (dots) by the number of inches between the center of the test marker 134 and the center of the test marker 136 to calculate the dots per inch. In some such implementations, the number of inches between the centers of 134 and 136 may be predetermined and accessible to the processor 16 as part of the stored data describing the line scan camera test target 100.

In various embodiments, the processor 16 may determine a global DPI value by determining the DPI between the first DPI test marker 134 and the second DPI test marker 136, as indicated by arrow GDPI in FIG. 4. Since the first DPI test marker 134 is positioned in the top end portion 110 and the second DPI test marker 136 is positioned in the bottom end portion 112, the global DPI value is representative of the average DPI for the entire test target 100. In some embodiments, the processor 16 may be configured to determine a global DPI difference between the global DPI value and a target global DPI value. The target DPI value is defined by the optics. The DPI value should be equal to the LPI value so that geometric shapes are not distorted (e.g., circles remain round and not ovals). Thus, for example, the target DPI may be 256 dots per inch to match a target LPI of 256 lines per inch.

In some embodiments, the processor 16 may be configured to compare the global LPI value with the global DPI value. For example, in some embodiments, the processor 16 may be configured to determine a horizontal distortion value, represented as a unitless percentage, defined as the ratio of the global LPI value versus the global DPI value, which may be treated as an absolute value.

In some embodiments, the processor 16 may be configured to provide an alarm indicator if the global DPI difference exceeds a global DPI difference threshold value (e.g., greater than 1% difference). In some embodiments, the processor 16 may be configured to provide an alarm indicator if the horizontal distortion value exceeds a horizontal distortion threshold value. In some embodiments, as described further below, the processor 16 may modify, adjust, or control the operation of one or more devices of the system 10 to correct a triggering alarm indication. For example, the processor 16 may control or change the settings or the operation of the camera 14, of the lighting, and/or of the mover 22.

Referring to FIGS. 2 and 4, in some embodiments, the line scan camera test target 100 may include a localized dots-per-inch (DPI) test portion 140. The localized DPI test portion 140 may be configured in a variety of ways. In some embodiments, the localized DPI test portion 140 may include two or more localized DPI test markers 142. The localized DPI test markers 142 may be configured in a variety of ways, including, but not limited to, shape, size, location, color, orientation, and arrangement.

In some embodiments, the localized DPI test markers 142 may be spaced apart in a line extending in the vertical direction T (i.e., perpendicular to the transport direction D). In some embodiments, the localized DPI test portion 140 may include a first localized DPI test marker 144 in the top end portion 110, a second localized DPI test marker 146 in the bottom end portion 112 spaced apart from the first localized DPI test marker 144, and a third localized DPI test marker 148 between the first localized DPI test marker 144 and the second localized DPI test marker 146 in a central portion 149. In some embodiments, the first, the second, and the third localized DPI test markers 144, 146, 148 may be evenly spaced apart in a line extending in the vertical direction T. The spacing may be predetermined and known and stored from the production specifications of the line scan camera test target 100. In some embodiments, the first, the second, and the third localized DPI test markers 144, 146, 148 may be in the trailing end portion 108.

In some embodiments, each of the first, the second, and the third localized DPI test markers 144, 146, 148 may be configured the same. For example, in some embodiments, the first localized DPI test markers 144 may include a first slanted edge 150 extending in the transport direction D, (i.e., across the vertical direction T), the second localized DPI test marker 146 may include a second slanted edge 152 extending in the transport direction D, and the third localized DPI test marker 148 may include a third slanted edge 154 extending in the transport direction D. Each of the first, the second, and the third slanted edges 150, 152, 154 may slant at an angle α relative to the vertical direction T in the range of 3 degrees to 7 degrees, which the system may use to account for the effects of digital aliasing. In some embodiments, the first, localized DPI test marker 144 may have a first slanted end edge 150 and a second slanted end edge 151 opposite the first slanted end edge 150. Likewise, the second localized DPI test marker 146 may have a first slanted end edge 152 and a second slanted end edge 153 opposite the first slanted end edge 152 and the third localized DPI test marker 148 may have a first slanted end edge 154 and a second slanted end edge 155 opposite the first slanted end edge 154., In some embodiments, the first localized DPI test marker 144 may have a first height H1 measured between the trailing ends of the first slanted end edge 150 and the second slanted end edge 151, the second localized DPI test marker 146 may have a second height H2 measured between the trailing ends of the first slanted end edge 152 and the second slanted end edge 153, and the third localized DPI test marker 148may have a third height H3 measured between the trailing ends of the first slanted end edge 154 and the second slanted end edge 155. In some embodiments, the first height H1, the second height H2, and the third height H3 may be configured to be the same on the test target 100.

In some embodiments, the processor 16 may be operable to execute instructions to analyze the image data from the line scan camera 14 and calculate or determine the first height H1 (indicative of a first localized vertical DPI) vertically between the first slanted end edge 150 and the second slanted end edge 151 of the first localized DPI test marker 144, the second height H2 (indicative of a second localized vertical DPI) vertically between the first slanted end edge 152 and the second slanted end edge 153 of the second localized DPI test marker 146 and the third height H3 (indicative of a third localized vertical DP) vertically between the first slanted end edge 154 and the second slanted end edge 155 of the third localized DPI test marker 148. In some embodiments, the first, second, and third heights H1, H2, H3 are determined vertically between the end edges, for example, by determining the number of vertical pixels P between the first slanted end edge 150 and the second slanted end edge 151 and multiplying that number by the vertical dimension of a pixel (e.g., 0.004 inches). The distance between the first slanted end edge 150 and the second slanted end edge 151, however, may be determined other than vertically between the end edges as long as the measurement if performed the same for each of the localized DPIO test markers 144, 146, 148, For example, in some embodiments the height measurement between the end edges may be perpendicular to the slanted end edges or at some other angle between the end edges. The first, second, and third heights H1, H2, H3, may be compared when the height measurement is the same for all three localized DPI test markers 144, 146, 148.

In some embodiments, the processor 16 may be configured to determine a vertical DPI end balance defined as a ratio of the first localized vertical DPI (LDPI-1) versus the second localized vertical DPI (LDPI-2), which may be a unit-less percentage and may be treated as an absolute value. If the first localized vertical DPI (LDPI-1) and the second localized vertical DPI (LDPI-2) are the same, the vertical DPI end balance will be 100.0%. In some embodiments, the processor 16 may be configured to provide an alarm indicator if the vertical DPI end balance is less than a vertical DPI end balance threshold value. In some embodiments, as described further below, the processor 16 may modify, adjust, or control the operation of one or more devices of the system 10 to correct a triggering alarm indication related to the vertical DPI end balance.

In some embodiments, the processor 16 may be configured to determine a vertical distortion value defined as a ratio of the average of the first localized vertical DPI (LDPI-1) and the second localized vertical DPI (LDPI-2) versus the third localized vertical DPI (LDPI-3), which may be a unit-less percentage and may be treated as an absolute value. If the average of the first localized vertical DPI (LDPI-1) and the second localized vertical DPI (LDPI-2) is the same as the third localized vertical DPI (LDPI-3), then the vertical distortion will be 0.0%. In some embodiments, the processor 16 may be configured to provide an alarm indicator if the vertical distortion value exceeds a vertical distortion threshold value. In some embodiments, as described further below, the processor 16 may modify, adjust, or control the operation of one or more devices of the system 10 to correct a triggering alarm indication related to the vertical distortion value.

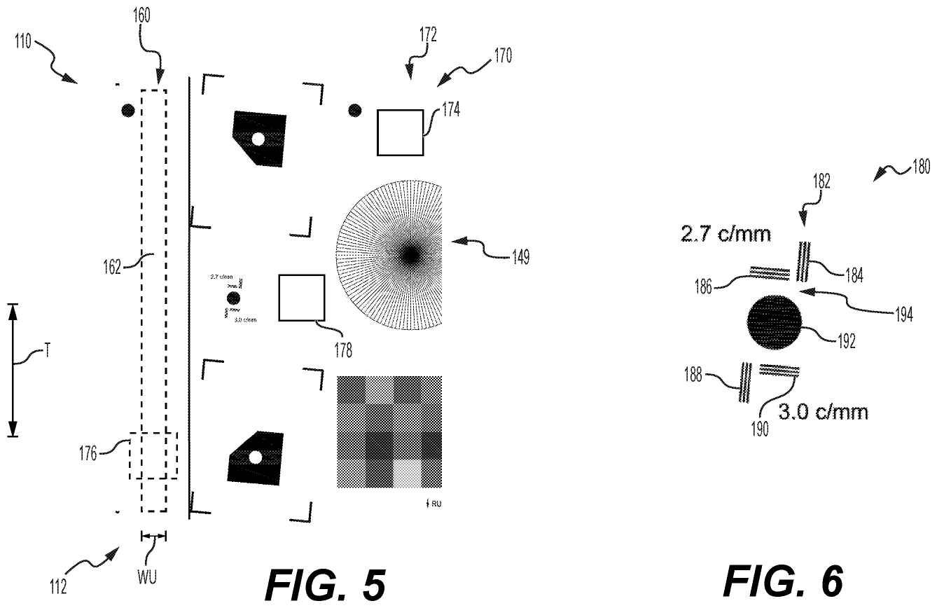

Referring to FIGS. 2 and 5, in some embodiments, the line scan camera test target 100 may include a uniformity test portion 160 configured to provide a target zone reflected LED illumination and lens focused return light collection profile for the line scan camera 14. The uniformity test portion 160 may be configured in a variety of ways, including size, shape, and location. In some embodiments, the uniformity test portion 160 may include an uninterrupted white test area 162 (as shown by dashed lines in FIG. 5), having a uniform grayscale value (e.g., uniform whiteness), extending from the top end portion 110 to the bottom end portion 112 in the vertical direction T and having a width WU of at least three, but preferably more, pixels.

In some embodiments, the line scan camera 14 may scan the white test area 162 and the processor 16 may be operable to execute instructions to calculate or determine, based on the image derived from scanning the white test area 162, a uniformity value. In some embodiments, the processor 16 may be configured to determine a uniformity value indicative of the difference in the grayscale values of the pixels being evaluated. For example, in some embodiments, the uniformity value may be a unit-less percentage and may be treated as an absolute value. If the average grayscale values of the pixels being evaluated are the same, the uniformity value is 100%. For example, in some embodiments, the processor 16 may determine a first average grayscale value of a first vertical pixel location across multiple scan lines (e.g., same vertical position across consecutive scan lines, such as the first three consecutive scan lines) in the white test area 162, a second average grayscale value of a second vertical pixel location across the multiple scan lines, and a third average grayscale value of a third vertical pixel location across the multiple scan lines. The processing performed by the processor 16 may further include determining a uniformity value indicative of the difference between any two of the average grayscale values (or all three average grayscale values). Thus, the grayscale value of pixels in multiple scan lines (e.g., 2-4 lines) may be averaged horizontally before processing the data vertically to obtain a uniformity analysis result. In some embodiments, the additional scan lines may be consecutive in the transport direction. The number of scan lines and the number of vertical pixel locations used for the uniformity analysis may vary in different embodiments. The processing performed by the processor may further include providing an alarm indicator if the uniformity value is less than a uniformity threshold value (e.g., 93% or lower). In some embodiments, more than three sets of vertical pixel locations may be evaluated to determine a uniformity value.

In some embodiments, as described further below, the processor 16 may modify, adjust, or control the operation of one or more devices of the system 10 to correct a triggering alarm indication related to the uniformity value.

In some embodiments, the processor 16 may be configured to detect a dead pixel. In some such embodiments, the processor 16 may determine, based on the image derived from a scan line, the grayscale values for each of three consecutive pixels along the scan line in the uniformity test white area (e.g., the first, the second, and the third pixels of the scan line SL).

The processor 16 may be further configured to determine the difference between grayscale value of the middle pixel of the three consecutive pixels (e.g., the second pixel) and the grayscale value of each of the end pixels bracketing the middle pixel (e.g., the first and third pixels) and/or the average grayscale value of the two end pixels. In some embodiments, the processor may be configured to provide an alarm indicator if the maximum difference in the grayscale value of the middle pixel and each of the end pixels and/or the average of the end pixels exceeds a dead pixel threshold value, such as 50%, 55%, 60%, 65%, or more. In some embodiments, if the dead pixel threshold value is exceeded, the determined uniformity value is automatically reduced to an artificially low number to serve as the alarm indicator. For example, the determined uniformity value may be reduced to a value below 50%. In some embodiments, the process 16 may be further configured to use the difference of the grayscale values of the bracketing pixels (e.g., the first and third pixels) to determine if the dead pixel check is warranted—that is, to trigger a dead-pixel test on the suspect pixel.

In some embodiments, the line scan camera 14 may scan the white test area 162 one or more times. For each of the one or more scan lines SL, the processor 16 may be configured to determine a grayscale value for each pixel in a group of contiguous pixels along the scan line. In some embodiments, the group of contiguous pixels may include a pixel at or near the midpoint of the scan line length (e.g., field of view middle pixel) and a specified number of pixels on either side (e.g., +/−200 pixels).

In some embodiments, the processor 16 may be further configured to determine a global white level by determining an average gray scale value of the group of contiguous pixels. In some embodiments, the processor 16 may be configured to provide an alarm indicator if average gray scale value falls outside a target grayscale value range (e.g., outside the range of 215 to 230 grayscale value). In some embodiments, as described further below, the processor 16 may modify, adjust, or control the operation of one or more devices of the system 10 to correct a triggering alarm indication related to the gray scale value.

In some embodiments, the processor 16 may be further configured to determine a difference between a maximum grayscale value and a minimum grayscale value of the pixels in the group of contiguous pixels. In some embodiments, the processor 16 may be configured to provide an alarm indicator if maximum difference in the grayscale value of the pixels in the group of contiguous pixels exceeds a grayscale value difference threshold value (e.g., greater than 5% difference). In some embodiments, as described further below, the processor 16 may modify, adjust, or control the operation of one or more devices of the system 10 to correct a triggering alarm indication related to the grayscale value difference.

Referring to FIGS. 2 and 5, in some embodiments, the line scan camera test target 100 may include a signal-to-noise ratio (SNR) test portion 170. The SNR test portion 160 may be configured in a variety of ways. In some embodiments, the SNR test portion 170 may include a plurality of specific white background areas 172 (e.g., 174, 176, 178) on the test face 102. The plurality of white background areas 172 may be configured in a variety of ways, including the number of areas 172 and the size, shape, and location of each of plurality of white background areas 172.

In some embodiments, the SNR test portion 170 may include a first SNR white test area 174 positioned in the top end portion 110, a second SNR white test area 176 positioned in the bottom end portion 112, and a third SNR white test area 178 positioned between the top end portion 110 and the bottom end portion 112 in the central portion 149. In some embodiments, the first SNR white test area, the second SNR white test area, and the third SNR white test area have the same, or nearly the same, grayscale value on the test target 100. In some embodiments, the first SNR white test area 174, the second SNR white test area 176, and the third SNR white test area 178 may be positioned at different locations relative to, or along, the transport direction D. For example, in the illustrated example, the second SNR white test area 176 may be forward (i.e., closer to the leading end portion 106) than the third SNR white test area 178 which may be forward of the first SNR white test area 174. In some embodiments, all or a portion of one or more of the first SNR white test area 174, the second SNR white test area 176, and/or the third SNR white test area 178 may be positioned in the white test area 162 of the uniformity test portion 160.

In some embodiments, the processor 16 may be operable to execute instructions to determine, based on the image data representing multiple scan lines SL of the test face 102, a first SNR value for a plurality of pixels in a first SNR white test area 174, a second SNR value for a plurality of pixels in a second SNR white test area 176, and a third SNR value for a plurality of pixels in a third SNR white test area 178. The first, second and third SNR values may be determined by the processor 16, based on the image data collected, in a conventional manner by known techniques/equations. The SNR of a camera describes the ratio between the light signal and the image noise. Generally, a higher SNR means a clearer image with less noise, which contributes to better image quality. The perfect line scan camera 104 would convert a known amount of light from a white surface (e.g., a white test area 174, 176, 178) into a certain predictable output (e.g., voltage) that is represented in the digital image data produced by the camera 104. But, due to sensor imperfections, temperature conditions, electronic interference, and other factors, the camera 104 does not convert light into image data with 100% accuracy. Sometimes the output voltage, and the corresponding digital image data, is slightly higher than expected and sometimes slightly lower. The difference between the expected ideal signal and the signal actually received (and represented in the image data) is referred to as noise. The ratio between signal (e.g., the predicted, ideal signal level) and noise (e.g., the observed signal level represented in the image data) is referred to as the signal-to-noise ratio (SNR), which may be expressed as a factor, (e.g., 20:1, 30:1, etc.), or expressed in decibels (dB).

In some embodiments, the processor 16 may be configured to determine a maximum difference (e.g., percent difference) between the first SNR value, the second SNR value, and the third SNR value. In some embodiments, the processor 16 may be configured to provide an alarm indicator if the maximum difference between the first SNR value, the second SNR value, and/or the third SNR value exceeds a SNR threshold value (e.g., a maximum 2% difference, greater than that triggers the alarm indicator). A SNR maximum difference that exceeds the SNR threshold value may be indicative of a soiled test target or dirty optics. Thus, in some embodiments, the alarm indicator may be interpreted by the user a need to check/clean/replace the test target, clean the camera optics, etc.

Referring to FIGS. 2 and 6, in some embodiments, the line scan camera test target 100 may include a mini-monochrome resolution test portion 180 with a location fiducial having orthogonally oriented, slanted (with respect to the vertical direction T and the transport direction D), modulated bar/space pairs (e.g., 182). In some embodiments, the mini-monochrome resolution test portion 180 may be configured to provide an easily understood visual indication of the resolving power of the line scan camera system 10. The mini-monochrome resolution test portion 180 may be configured in a variety of ways, including, but not limited to, shape, size, location, color, orientation, and arrangement. In some embodiments, the mini-monochrome resolution test portion 180 may include one or more (two are shown in the example of FIG. 6) orthogonally oriented, slanted, modulated bar/space patterns 182. In some embodiments, the one or more bar-space patterns 182 may be arranged in vertical-horizontal pairs (e.g., 184 and 186 are one vertical-horizontal pair).

In some embodiments, as shown in FIG. 6, the mini-monochrome resolution test portion 180 may include a first slanted bar-space pattern 184 extending at a slight angle or slant relative to the vertical direction T, a second slanted bar-space pattern 186 extending at a slight angle or slant relative to the transport direction D, a third slanted bar-space pattern 188 extending at a slight angle to the vertical direction T, and a fourth slanted bar-space pattern 190 extending at a slight angle to the transport direction D.

In some embodiments, the spacing or spatial frequency (i.e., the distance between bar portions) of some of the bar-space patterns may differ from the spacing or spatial frequency of one or more other bar-space patterns. For example, in the illustrated embodiment, the first and the second slanted bar-space patterns 184, 186 may have a first spacing and the third and fourth bar-space patterns 188, 190 have a second spacing that is different that the first spacing. In some embodiments, the first and the second slanted bar-space patterns 184, 186 may be 2.7 cycles/mm bar-space patterns having a spacing of approximately 0.0073 inch between bars/spaces and the third and fourth slanted bar-space patterns 188, 190 may be 3.0 cycles/mm bar-space patterns having a spacing of approximately 0.0066 inch between bars/spaces. In line scan camera technology, cycles per millimeter refers to the amount of line pairs (black and white lines) within one millimeter in the sensor plane of the camera 14. It is a measure of spatial frequency, expressing how many line pairs can be found in a given distance.

In some embodiments, the mini-monochrome resolution test portion 180 may include a black color reference area adjacent to a white color reference area. For example, in some embodiments, the mini-monochrome resolution test portion 180 may include a black finder marker 192 on a white background area 194 which may act as a local black/white static low spatial frequency reference (using the white surrounding 194). The black finder marker 192 may be configured in a variety of ways, including size, shape, location, etc. In some embodiments, the black finder marker 192 may be a solid black dot or circle, as shown.

The mini-monochrome resolution test portion 180 may be used for a modulation transfer function (MTF) calculation that utilizes the black finder marker 192 and white background area 194 as a reference point. For example, the white background area 194 may be configured to have the same gray scale value as the spaces in the bar/space patterns 184, 186, 188, 190 (i.e., the high spatial frequency targets) and the finder marker 192 may have the same black value as the bars in the bar/space patterns. In some embodiments, the black finder marker 192 and the white background area 194 are large enough to ensure getting a value from an image of the marker 192 and the background area 194 that is void of any of the effects of sample aliasing. To determine or calculate the MTF, the processor may compare the measurement amplitudes in the image data from the high spatial frequency patterns 184, 186, 188, 190 to the white/black reference from the image data from the marker 192 and background area 194, and the resultant MTF value may be expressed in the form of a percentage. For instance, if the system resolving power was such that the white levels and the black levels of the bar/space patterns were equal to the white levels and the black levels of the reference black finder marker 192 and the white background area 194, then the MTF would be 100%.

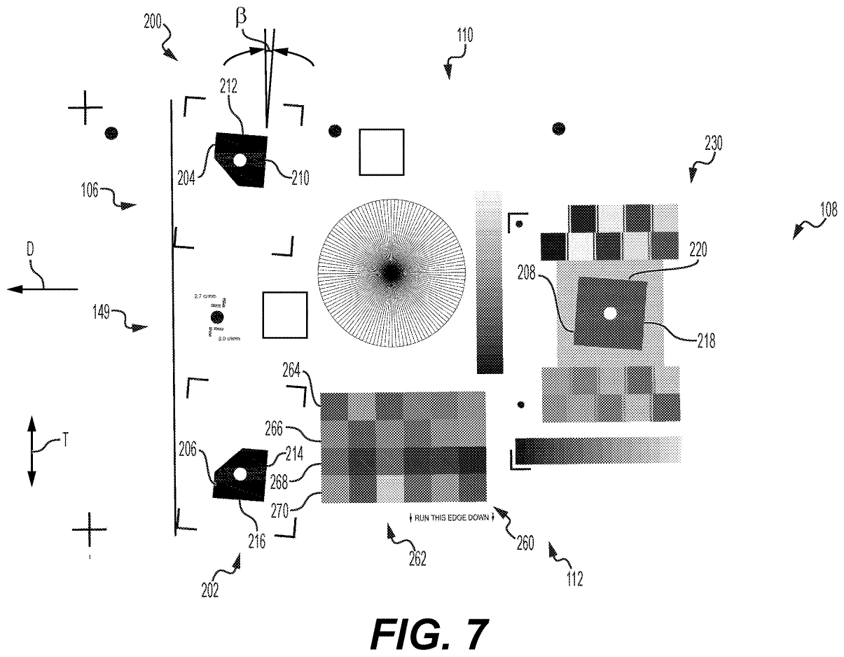

Referring to FIGS. 2 and 7, in some embodiments, the line scan camera test target 100 may include a spatial frequency response (SFR) test portion 200. The SFR test portion 200 may be configured in a variety of ways. In some embodiments, the SFR test portion 200 may include a plurality of SFR test markers 202. The SFR test markers 202 may be configured in a variety of ways, including, but not limited to, shape, size, location, orientation, and arrangement. Spatial frequency response (SFR) is a multi-valued metric that measures contrast loss of a camera (e.g., 14) as a function of spatial frequency. One common SFR measurement method is known as E-SFR (see, e.g., ISO 12233), which measures the camera's response to a slanted edge.

In some embodiments, the SFR test portion 200 may include a first SFR test marker 204 in the top end portion 110, a second SFR test marker 206 in the bottom end portion 112, and a third SFR test marker 208 in the central portion 149. In some embodiments, the first SFR test marker 204 and the second SFR test marker 206 may be in the leading end portion 106. In some embodiments, the first SFR test marker 204 and the second SFR test marker 206 may be aligned with each other in the vertical direction T.

In some embodiments, each of the first, the second, and the third SFR test markers 204, 206, 208 may be configured for both vertical (i.e., in the transverse direction T) and horizontal (i.e., in the transport direction D) SFR analysis to be performed on them. In some embodiments, the first SFR test marker 204 may include a first slanted edge 210 extending at a slight or minor angle relative to the vertical direction T and a second slanted edge 212 extending at a slight or minor angle relative to the transport direction D. Similarly, in some embodiments, the second SFR test marker 206 may include a third slanted edge 214 extending at a slight angle relative to the vertical direction T and a fourth slanted edge 216 extending at a slight angle relative to the transport direction D. Further, in some embodiments, the third SFR test marker 208 may include a fifth slanted edge 218 extending at a slight angle relative to the vertical direction T and a sixth slanted edge 220 extending at a slight angle relative to the transport direction D.

In some embodiments, the first slanted edge 210, the third slanted edge 214, and the fifth slanted edge 218 may slant at an angle β relative to the vertical direction T in the range of about 3 degrees to 7 degrees. Similarly, the second slanted edge 212, the fourth slanted edge 216, and the sixth slanted edge 220 may slant at a similar angle (e.g., in the range of about 3 degrees to 7 degrees) relative to the transport direction.

In some embodiments, the processor 16 may be operable to execute instructions to perform SFR analysis on images (e.g., image data from the camera 14) of the first, the second, and/or the third SFR test markers 204, 206, 208. In some embodiments, a first SFR analysis may be performed using a conventional “sampling efficiency” approach where the 10% SFR performance limit is compared against the spatial frequency of 0.5 cycles/pixel (or one pixel being half a cycle). If the result at 0.5 cycles/pixel is greater than or equal to 10% SFR (SFR-10), the result is said to yield 100% sampling efficiency. In some embodiments, an additional or alternative second SFR analysis may be performed that uses the 50% SFR (SFR-50). The 50% result may be used to determine the equivalent spatial frequency in cycles per pixel. Under this second approach, nuances in the performance curve will shift the spatial frequency result, allowing for a higher resolution classification.

In some embodiments, the processor 16 may be configured to use either the first SFR analysis approach or the second SFR analysis approach. In some embodiments, the processor may be configured to use both the first SFR analysis approach and the second SFR analysis approach. For example, in some embodiments, the first SFR analysis approach may be performed six times on the test targets: a vertical SFR analysis and a horizontal SFR analysis on each of the first, the second, and the third SFR test markers 204, 206, 208. Further, the second SFR analysis approach may be performed six times on the test targets: a vertical SFR analysis and a horizontal SFR analysis on each of the first, the second, and the third SFR test markers 204, 206, 208. The horizontal SFR analyses (transport axis D) may be performed on the vertical slanted edges 210, 214, 218 of each of the first, the second, and the third SFR test markers 204, 206, 208 and the vertical SFR analyses (sensor axis T) may be performed on the horizontal slanted edges 211, 216, 220 of each of the first, the second, and the third SFR test markers 204, 206, 208. Using the two analysis approaches for the resulting SFR calculation, a total of twelve analysis points could be considered when determining the resolving power performance of the camera 14. In particular, in some embodiments, the processor 16 may be configured, based on the image data from the multiple scan lines (e.g. SL) of the test face 102, to calculate or determine a first vertical SFR at 0.5 cycles per pixel based on the first SFR test marker 204, a second vertical SFR at 0.5 cycles per pixel based on a second SFR test marker 206, and a third vertical SFR at 0.5 cycles per pixel based on a third SFR test marker 208. In some embodiments, the processor 16 may be configured to determine a first vertical SFR difference between the first vertical SFR at 0.5 cycles per pixel and the second vertical SFR at 0.5 cycles per pixel. In some embodiments, the processor 16 may be configured to determine a second vertical SFR difference between the third vertical SFR at 0.5 cycles per pixel and one of the first vertical SFR at 0.5 cycles per pixel, the second vertical SFR at 0.5 cycles per pixel, or the average of the first and second vertical SFR at 0.5 cycles per pixel. In some embodiments, the processor 16 may be configured to provide an alarm indicator if the first vertical SFR difference or the second vertical SFR difference exceeds a vertical SFR difference threshold value (e.g., greater than 1% difference). In some embodiments, as described further below, the processor 16 may modify, adjust, or control the operation of one or more devices of the system 10 to correct a triggering alarm indication related to the vertical SFR difference.

In some embodiments, the processor 16 may be configured, based on the image data from the multiple scan lines of the test face, to determine a first horizontal SFR at 0.5 cycles per pixel based on the first SFR test marker, a second horizontal SFR at 0.5 cycles per pixel based on the second SFR test marker, and a third horizontal SFR at 0.5 cycles per pixel based on the third SFR test marker. In some embodiments, the processor 16 may be configured to determine a first horizontal SFR difference between the first horizontal SFR at 0.5 cycles per pixel and the second horizontal SFR at 0.5 cycles per pixel. In some embodiments, the processor 16 may be configured to determine a second horizontal SFR difference between the third horizontal SFR at 0.5 cycles per pixel and one of the first horizontal SFR at 0.5 cycles per pixel, the second horizontal SFR at 0.5 cycles per pixel, or the average of the first and second horizontal SFR at 0.5 cycles per pixel. In some embodiments, the processor 16 may be configured to provide an alarm indicator if the first horizontal SFR difference or the second horizontal SFR difference exceeds a horizontal SFR difference threshold value (e.g., greater than 1% difference). In some embodiments, as described further below, the processor 16 may modify, adjust, or control the operation of one or more devices of the system 10 to correct a triggering alarm indication related to the horizontal SFR difference.

In some embodiments, the processor 16 may be configured, based on the image data from the multiple scan lines of the test face, to determine a first vertical cycles-per-pixel (CPP) interval at 50% SFR (SFR-50) based on the first SFR test marker, a second vertical CPP at SFR-50 based on the second SFR test marker, and a third vertical CPP at SFR-50 based on the third SFR test marker. In some embodiments, the processor 16 may be configured to determine a first vertical CPP interval difference between the first vertical CPP at SFR-50 and the second vertical CPP at SFR-50. In some embodiments, the processor 16 may be configured, to determine a second vertical CPP interval difference between the third vertical CPP at SFR-50 and one of the first vertical CPP at SFR-50, the second vertical CPP at SFR-50 or the average of the first and second vertical CPP at SFR-50. In some embodiments, the processor 16 may be configured to provide an alarm indicator if the first vertical CPP interval difference or the second vertical CPP interval difference exceeds a vertical CPP interval difference threshold value (e.g., greater than 1% difference). In some embodiments, as described further below, the processor 16 may modify, adjust, or control the operation of one or more devices of the system 10 to correct a triggering alarm indication related to the vertical CPP interval difference.

In some embodiments, the processor 16 may be configured, based on the image data from the multiple scan lines of the test face, to determine a first horizontal cycles-per-pixel (CPP) interval at 50% SFR (SFR-50) based on the first SFR test marker, a second horizontal CPP at SFR-50 based on the second SFR test marker, and a third horizontal CPP at SFR-50 based on the third SFR test marker. In some embodiments, the processor 16 may be configured to determine a first horizontal CPP interval difference between the first horizontal CPP at SFR-50 and the second horizontal CPP at SFR-50. In some embodiments, the processor 16 may be configured to determine a second horizontal CPP interval difference between the third horizontal CPP at SFR-50 and one of the first horizontal CPP at SFR-50, the second horizontal CPP at SFR-50 or the average of the first and second horizontal CPP at SFR-50. In some embodiments, the processor 16 may be configured to provide an alarm indicator if the first horizontal CPP interval difference or the second horizontal CPP interval difference exceeds a horizontal CPP interval difference threshold value (e.g., greater than 1% difference). In some embodiments, as described further below, the processor 16 may modify, adjust, or control the operation of one or more devices of the system 10 to correct a triggering alarm indication related to the horizontal CPP difference.

Referring to FIGS. 2 and 8, in some embodiments, the test target 100 may include an optical efficiency conversion factor (OECF) test portion 230. OECF in cameras refers to the relationship between the number of bits and the maximum signal level in digital cameras. The OEFC test portion 230 may be configured in a variety of ways. In some embodiments, the OEFC test portion 230 may include a plurality of OECF test markers 232, (e.g., squares or rectangular cells, as shown), each having a different grayscale value. In some embodiments, the plurality of OECF test markers or cells 232 may be positioned in an arrangement of decrementing grayscale values (e.g., evenly decrementing). In some embodiments, the arrangement of decrementing grayscale values includes a zig-zag pattern.

In some embodiments, the plurality of OEFC test markers 232 may be arranged in a plurality of rows. For example, in some embodiments, OEFC test portion 230 may include a first row 234, a second row 236 below the first row (i.e., closer to the bottom end portion 112), a third row 238 below the second row 236, and a fourth row 240 below the third row 238. In other embodiment, the plurality of OEFC test markers 232 may be arranged in more or less than four rows.

In some embodiments, the plurality of OECF test markers 232 may have an overall grayscale value range and the OECF test markers 232 may be arranged in pairs wherein each pair includes a OECF test marker 232 with a grayscale value in the lower half of the range positioned adjacent (e.g., in the vertical direction) to an OEFC test marker 232 with a grayscale value in the upper half of the range. In other words, cells may be configured or organized to have adjacent cells converge to mid-point values where half the brighter values are considered background, and the remaining are considered foreground.

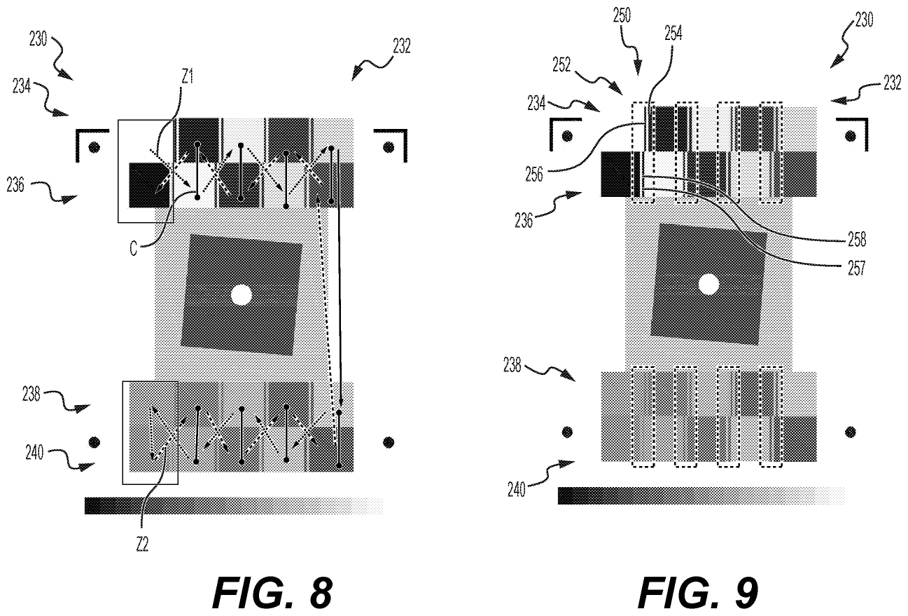

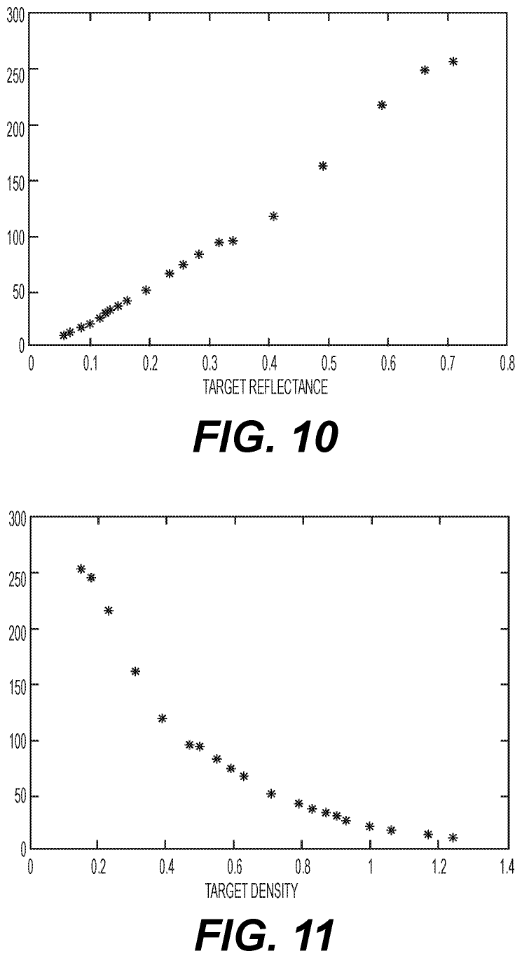

In some embodiments, as shown in FIG. 9, the plurality of OECF markers may include twenty (20) OECF test markers or cells 232 ranging from a grayscale value of 251 to a grayscale value of 4 with each successive OECF test marker 232 decrementing by a grayscale value of 13. In other embodiments, however, the number of OECF test markers 232, the maximum and minimum grayscale values, the overall grayscale range, and/or the amount that successive OECF test markers decrement in grayscale value may differ.

In the illustrated example of twenty (20) OECF test markers 232, each of the first row, the second row, the third row, and the fourth row contain five OECF test markers 232. In particular, from left to right in FIG. 9, a first, a second, a third, a fourth, and a fifth OECF test markers 232. In some embodiments, the first OECF test marker in the first row 234 and the first OECF test marker in the second row 236 may form a first pair, the second OECF test marker in the first row 234 and the second OECF test marker in the second row 236 may form a second pair, and so on. Similarly, pairs may be formed by the first OECF test marker in the third row 238 and the first OECF test marker in the fourth row 240, by the second OECF test marker in the third row 238 and the second OECF test marker in the fourth row 240, and so on.

In the illustrated example, the first OECF test marker in the first row 234 may have a grayscale value for 251 (i.e., the maximum grayscale value of the twenty OECF test markers 232) and the first OECF test marker in the second row 236 has a grayscale value of 4 (i.e., the minimum grayscale value of the twenty OECF test markers 232). Thus, the first OECF test markers in the first and second rows have the highest contrast levels of the pairs of OECF test markers 232. The contrast between OECF test marker pairs in the first and second rows 234, 236 (i.e., vertically in FIG. 9 as shown by line C) and the third and fourth rows 238, 240, will be an odd integer value between 1 and 19 multiplied by 13.

In the illustrated embodiment, the OECF test markers 232 may decrement in a zig-zag pattern, as shown by arrows Z1 in FIG. 9. For example, the second OECF test marker in the second row 236 may have a grayscale value of 238 (i.e., 13 less than the 251 grayscale value of the first OECF test markers in the first row. Similarly, the third OECF test marker in the first row 234 may have a grayscale value of 225, the fourth grayscale value of the second row 236 may have a grayscale value of 212 and the fifth OECF test marker of the first row may have a grayscale value of 199.

A similar zig-zag pattern may occur in the third and fourth rows 238, 240 continuing to decrement from the fifth OECF test marker in the first row 234 may have a grayscale value of 199. In particular, the fifth OECF test marker in the third row 238 may have a grayscale value of 186, the fourth OECF test marker in the fourth row 240 may have a grayscale value of 173, and so on to the first OECF test marker in the third row with a grayscale value of 134.

The first OECF test marker in the fourth row 240 may have a grayscale value of 121 (i.e. 13 less than the grayscale value of the first OECF test marker in the third row). The first OECF test markers in the third row 238 and the fourth row 240 form the lowest contrast level of the pairs of OECF test markers 232.

From the first OECF test marker in the fourth row 240, the zig-zag pattern of decrementing grayscale values continues in the opposite direction, as shown by arrows Z2 in FIG. 9. Thus, the second OECF test marker in the third row 238 may have a grayscale value of 108, the third OECF test marker in the fourth row 240 may have a grayscale value of 95, and so on to the first OECF marker in the second row with a grayscale value of 4. The purpose of the converging adjacent gray scale value cells with the associated bar/space pattern is to identify limits as to where the decrementing contrast levels eventually cause the camera to fail to generate accurate binary data. Another purpose is to find out the limits of binarization failure of the camera, where binarization failure is determined by background/foreground contrast levels and local SNR. A poor SNR may make detecting subtle gray value transitions difficult. Electronic noise, poor lighting and dirty/mis-aligned optics in a camera may affect the local SNR.

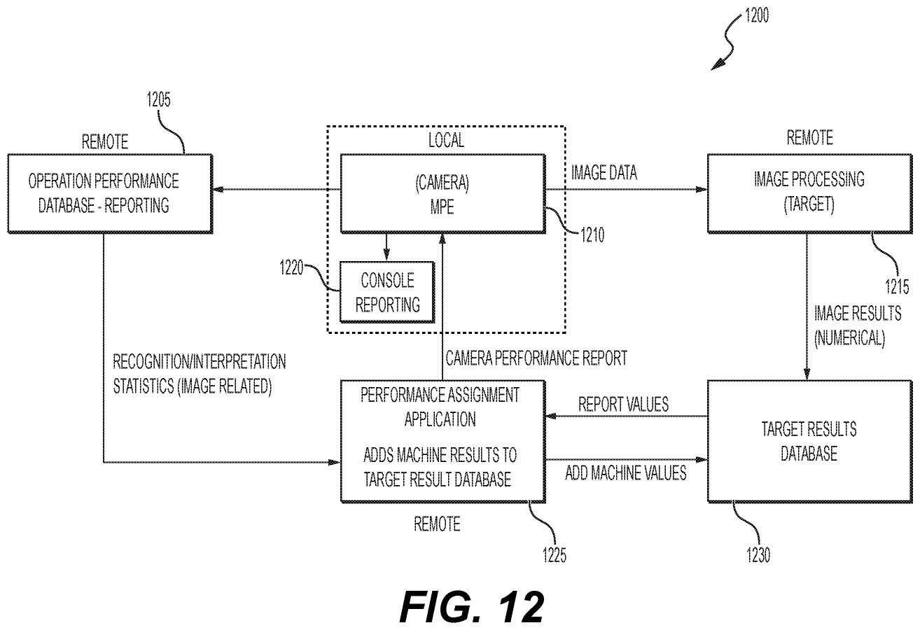

In some embodiments, the processor 16 may be operable to execute instructions to determine or calculate, based on the image data derived from the multiple scan lines (e.g., SL) of the test face, a reflectance value and a density value for each of the OECF test markers. In some embodiments, the processor 16 may be configured to calculate and/or plot the grayscale values versus the reflectance values and/or calculate and/or plot grayscale values versus the density values, as shown in example plots in FIG. 11 (grayscale value on the y-axis and target reflectance value on the x-axis) and FIG. 12 (grayscale value on the y-axis and target density on the x-axis). In some embodiments, the processor 16 may be configured to compare the shape of the reflectance response plot and the shape of the density response plot against pre-set, line-fitting limits. In some embodiments, the processor 16 may be configured to provide an alarm indication if the shape of the plot of the reflectance response and/or the shape of the plot of the density response falls outside of the pre-set, line-fitting limits (e.g., if the shape of the curve sags or is otherwise excessively non-linear) Any suitable criteria (e.g., non-linearity criteria) may be used for the pre-set line-fitting limits. For example, coefficient of determination (R-squared), Sum of Squared Errors (SSE), Root Mean Squared Error (RMSE), or other statistical measures may be used to as criteria to determine if the shape of the plot of the reflectance response and/or the shape of the plot of the density response is acceptable. In some embodiments, as described further below, the processor 16 may modify, adjust, or control the operation of one or more devices of the system 10 to correct a triggering alarm indication related to the density or reflective responses.

Referring to FIGS. 2 and 9, in some embodiments, the optical efficiency conversion factor (OECF) test portion 230 may include a binarization checking portion 250. The binarization checking portion 250 may be configured to test or measure the ability of the line scan camera system 10 to detect and binarize low-contrast edge areas (e.g., foreground vs. background conditions). The binarization checking portion may be configured in a variety of ways. In some embodiments, the binarization checking portion 250 may include a plurality of bar-space patterns 252. The bar-space patterns 252 may be configured in a variety of ways. In some embodiments, the bar-space patterns 252 may be vertical 20 mil bar-space patterns. In other alternative embodiments, the bar-space patterns 252 may have other widths, such as 10, 15, 25, or 30 mil bar-space patterns, or the like.

In some embodiments, as shown, the binarization checking portion 250 may include a bar-space pattern between the first OECF test marker and the second OECF test marker of each of the four rows 234, 236, 238, 240 of OECF test markers 232. Similarly, in some embodiments, the binarization checking portion 250 may include a bar-space pattern between the second OECF test marker and the third OECF test marker, between the third OECF test marker and the fourth OECF test marker, and between the fourth OECF test marker and the fifth OECF test marker in each of the four rows 234, 236, 238, 240.

For example, for the bar-space pattern 252 between the first and the second OECF test markers in the first row 234, the bar-space pattern 252 has a space 254 with a grayscale value equal to the grayscale value of the first OECF test marker in the first row 234 and a bar 256 with a grayscale value equal to the grayscale value of the second OECF test marker in the first row 234. In the illustrated example, the space 254 has a grayscale value of 251 and the bar has a grayscale value of 17, which is a contrast-level value of 234, (251 minus 17).

Similarly, for the bar-space pattern 252 between the first and the second OECF test markers in the second row 236, the bar-space pattern 252 has a space 257 with a grayscale value equal to the grayscale value of the second OECF test marker in the second row 236 and a bar 258 with a grayscale value equal to the grayscale value of the first OECF test marker in the second row 236 In the illustrated example, the space 257 has a grayscale value of 238 and the bar 258 has a grayscale value of 4 for a contrast value of 234. Thus, the bar-space patterns 252 between the first and the second OECF test markers in the first row 234 and the second row 236 form a bar-space pair with the same contrast level, which will be the greatest contrast level of the bar-space patterns 252 in the binarization checking portion 250.

The bar-space patterns between the second and the third OECF test markers, between the third and the fourth OECF test markers, and between the fourth and the fifth OECF test markers follow a similar pattern where the space 254 has the same grayscale value as the OECF test marker with the higher grayscale value and the bar 256 has the same grayscale value as the OECF test marker with the lower grayscale value. Thus, the bar-space patterns 252 between the first and the second OECF test markers 232 in the third row 238 and the fourth row 240 will have the least contrast of the bar-space patterns 252. For example, in the illustrated embodiment, the bar-space pattern 252 between the first OECF test marker and the second OECF test marker in the fourth row 240 has a contrast level of 26 because the space has a grayscale value of 147 and the bar has a grayscale value of 121. In some embodiments, the contrast of the bar-space patterns 252 may be an even integer value between 2 and 18 multiplied by 13.

In some embodiments, the processor 16 may be operable to execute instructions to convert the image derived from the multiple scans to binary data. The converted binary images can be analyzed to determine the contrast level at which the binarization algorithm recognizes (or ceases to recognize) foreground versus background, which can be an indication of, for example, how well the illuminator is working or if there is a signal to noise ratio problem on the line scan camera 14.

Referring to FIGS. 2 and 7, in some embodiments, the test target 100 may include a color test portion 260 configured to test the responsivity of the line scan camera 12 to the color spectrum. The color test portion 260 may be configured in a variety of ways. In some embodiments, the color test portion 260 may include a plurality of color test markers 262 each having a different calibration color. As shown in the example of FIG. 7, each of the color test markers 262 may be in the shape of a square or a rectangle.

The plurality of color test markers 262 may be configured in a variety of ways, including, but not limited to, size, shape, color, position, arrangement, and/or orientation. In some embodiments, the plurality of color test markers 262 may be arranged in a plurality of rows. For example, in some embodiments, the color test portion 260 may include a first row 264, a second row 266 below the first row (i.e., closer to the bottom end portion 112), a third row 268 below the second row 266, and a fourth row 270 below the third row 268. In other embodiments, the plurality of color test markers 262 may be arranged in more or less than four rows.

In the illustrated example, the color test portion 260 includes twenty-four (24) square-shaped color test markers 262, with the first row 264, the second row 266, the third row 268, and the fourth row 270 having six square-shaped color test markers 262 each. In particular, from left to right in FIG. 7, a first, a second, a third, a fourth, a fifth, and a sixth color test marker 262 in each row.

In some embodiments, two adjacent color test markers 262 may form a related pair. For example, in some embodiments, the first, the third, and the fifth color test marker in the third row 268 may be the primary colors red, green, and blue, respectively and the first, the third, and the fifth color test marker in the fourth row 270 may be the inverse color (i.e., cyan, magenta, and yellow) of the primary color, respectively.

In some embodiments, the second, the fourth, and the sixth color test marker in the third row 268 may be the half-color tint of the primary color of the first, the third, and the fifth color test markers in the third row 268, respectively. Further, the second, the fourth, and the sixth color test marker in the fourth row 270 may be the half-color tint of the inverse primary color of the first, the third, and the fifth color test markers in the fourth row 270, respectively. The configuration of the color test portion 260 allows for color channel calibration of the three primary sensor RGB color channels using full color and then half color tint to determine a camera's (e.g., 14) sensor dynamic range and linearity.

In some embodiments, the first row 264 and the second row 266 may include earth tone composite colors that are paired similarly to the pairs in the third row 268 and the fourth row 270 (e.g., one color represents a foreground color with the adjacent being a background color). The earth tone composition colors in the first and second rows 264, 266 may be used to help measure or determine the ability of the line scan camera (e.g., 14) to sense foreground color printing on the given color background. For example, in some implementations, the colors may be converted to gray scale (e.g., via a luma conversion performed by the processor 16 on the image data from the camera 14) and the resulting gray scale delta contrast may be determined and then compared to the comparable binary performance of the bar/space lines in the color markers in the third and fourth rows 268, 270.

The test target 100 may be used to calculate, measure, quantify, or determine various image quality attributes, as described herein. The disclosed attributes are specifically representative of the imaging performance of a line scan camera (e.g., 14), where such cameras typically record images in gray scale, or in color at lower resolutions (8-bit typical), and then convert the image data to a foreground/background binary equivalent for printed content processing (typically in real-time). The test target 100 and the computer-implemented (e.g., by the processor 16) operations and processes that process and analyze the image(s) of the test target 100 provide a novel, long-needed tools and methods for evaluating line scan cameras. Any measurements or evaluations of the disclosed attributes that indicate that the camera's performance or condition is outside of desired parameters, not within a predetermined range, or otherwise not acceptable (e.g., that generate an alarm condition) may be used as both or either: 1) a guide (e.g., for a technician, repairman, AI system, etc.) to identifying and troubleshooting issues with, or undesirable conditions of, the line scan camera system 10 and/or its operating environment, where the identified issues/conditions are likely to be responsible for negatively impacting imaging performance; and/or 2) a trigger or prompt for the processor 16 to automatically initiate checks, corrections, adjustments, control signals, changes, or the like to one or more element (e.g., device(s)) of the line scan camera system 10 in order to rectify the performance problem or condition indicated by an attribute. In various embodiments, the processor 16 may send digital data (e.g., control data or display data), control signals, or the like to the camera 14, the mover 20, the lights in the environment of the line scan camera system 10, the display monitor for a human operator of the line scan camera system 10, etc., to cause any needed corrections, adjustments, or other changes associated with the analyzed attributes associated with the test target 100.

Table 1, below, provides a guide to troubleshooting, automatically correcting, adjusting for, or otherwise addressing issues, problems, or conditions that were identified based on various attribute(s) in situations where the camera is determined to be under performing (e.g., where the analyzed attributes indicate that one or more camera or image property is outside a specific range, above or below a specific threshold value, the cause of an alarm condition or indication, etc.).

### Table 1: Results-Based Root Cause Determination and Corrective Actions

### Condition: SFR Results Indicating Degraded Resolution Performance

Horizontal versus Vertical
   Check/adjust camera exposure setting (image lag)
   Check for transport issues such as worn belts and backside foam roller adjustments
   Check/adjust tachometer settings, tach electrical connection/mounting and grounding
   Check for line rate clocking and RGB color registration issues (adjust camera calibration)
   Check/adjust for over-compensated white level correction gain table entries
Center to Ends deviation (Vertical)
   Check/adjust camera optical throw (working distance(s)—top and bottom)
   Check/remedy camera cleanliness
   Check/adjust for line rate clocking and RGB color registration issues (camera calibration)
   Check/adjust for over-compensated white level correction gain table entries
   Check/adjust swatch condition and camera gain setting (too high)
End Balance—Vertical
   Check/adjust camera optical throw (working distance(s)—top and bottom)
   Check/remedy camera cleanliness
   Check/adjust for line rate clocking and RGB color registration issues (camera calibration)
   Check/adjust for over-compensated white level correction gain table entries
   Check/adjust swatch condition and camera gain setting (too high)
End Balance—Horizontal (transport axis)
   Check/adjust for transport issues such as worn belts and backside foam roller adjustments
   Check/remedy camera cleanliness
   Check/adjust for line rate clocking and RGB color registration issues (camera calibration)
   Check/adjust for over-compensated white level correction gain table entries
   Check/adjust swatch condition and camera gain setting (too high)
Larger cycles/pixel sampling interval value for SFR-50 results (large slope)
   Check/remedy camera cleanliness
   Check/adjust all the conditions mentioned above
   Re-calibrate the camera, and re-test
   If issue continues, replace camera

### Condition: OECF—Failing Performance (Reflectance or Density)

Check/remedy camera cleanliness
Check for/remedy dust accumulation on camera lens face
Check/adjust LED output power regulation control swatch
Check/adjust camera gain setting for too high a value (increase LED output power instead)
Determine if results correlate with reported SNR issues (noisy images)
Determine if test target card is worn or damaged in the gray tile gradient area

### Condition: Lower White Level Uniformity Number

Check/remedy camera cleanliness
Check for/remedy dust accumulation on camera lens face
Check for/remedy worn target card (SNR results)
Check/adjust LED output power regulation control swatch
Run White Level Correction utility, and re-test
   Condition: Lower Avg. White Number, but Good Uniformity Results
Check/remedy camera cleanliness
Check/remedy for dust accumulation on camera lens face
Check for/remedy worn non-white test card (a.k.a. test target)
Check/adjust LED output power regulation control swatch
Adjust LED output power to bring Avg. White level in the proper range

### Condition: Signal to Noise (SNR) Deviations—Zone to Zone

Check/remedy camera cleanliness
Check/remedy for dust accumulation on camera lens face
Check for/remedy worn test card, replace if necessary or try alternate card
Check/adjust LED output power regulation control swatch
Check/adjust camera gain setting (too high)
Run White Level correction utility to replace gain table

### Condition: Signal to Noise (SNR)—Matching, but Larger Values

Check/remedy camera cleanliness
Check/remedy for dust accumulation on camera lens face
Check for/remedy worn test card, replace if necessary or try alternate card
Check/adjust LED output power regulation control swatch
Check/adjust camera gain setting (too high)
Run White Level correction utility to replace gain table
   Condition: LPI (global) Value off but Matching Segmented Values (−1 to −3) (Horiz.Dist.issues)
Check for/adjust transport related issues
Check/adjust tachometer settings, tach electrical connection/mounting and grounding
Check/adjust camera line rate clock multiplier settings
Replace camera
   Condition: LPI global value and segmented values varying (Horiz.Dist.issues)
Check for/adjust transport issues such as worn belts and backside foam roller adjustments
Check/adjust tachometer settings, tach electrical connection/mounting and grounding
Check/adjust camera line rate clock multiplier settings
Replace camera
   Condition: (vertical) End Balance (DPI—Vert.dist.Issues)
Check/adjust camera optical throw (working distance(s)—top and Bottom)
Check/remedy camera cleanliness
Check for/remedy dust accumulation on camera lens face
Check for/remedy worn test card, replace if necessary or try alternate card
Check for/adjust line rate clocking and RGB color registration issues (camera calibration)
Check for/adjust over-compensated white level correction gain table entries
Check/adjust swatch condition and camera gain setting (too high)

FIG. 12 illustrates a block diagram of an example system level workflow or process 1200 for assessing the imaging performance of a line scan camera (e.g., 14, 1210). The right side of the diagram illustrates a usage case for the novel, above-described test target. For example, for an application where the line scan camera may be used as part of a package sorting system, mail processing equipment (MPE), or the like, the process may include generating image data by imaging the test face of the test card/target 100 moving in the transport direction. The image data may then be processed 1215, as described above, to determine one or more image quality attributes or parameters (e.g., LPI, DPI, SFR, SNR, uniformity, etc.). In some embodiments, the processing 1215 may be done remotely from the camera locale. The image quality attributes may then be saved to a test target results database 1230 and used for comparison to various threshold values, target/desired parameters, or the like, to assess the camera's imaging performance.

In some embodiments, the system, devices, and methodology for assessing the imaging performance of the line scan camera may also include using camera-related statistical performance operational parameters. For example, the line scan camera (e.g., 14, 1210), as part of the MPE, may image mail during live operational mail runs. In some embodiments, the system may store operation performance data in a database 1205 for retrieval and reporting. In some embodiments, the system may include recognition/interpretation software 1225 configured to analysis the image data and determine performance parameters or metrics (e.g., a recognition score, a segmentation score, etc.) indicative of the performance during the live runs. The machine-measured operational performance may be baselined over multiple processing runs using existing and tuned application specific image interpretation software (e.g., 1225) that have, as inputs, camera generated image data. In some embodiments, the live results may be averaged over multiple runs to negate the effects of variability (e.g., skewed mail mixes).

As shown in the example of FIG. 12, the process 1200 may use the mail-processing-equipment-run results to establish, or contribute to establishing, the acceptable ranges, thresholds, etc., for all of the test-target-data-set-measured parameters, which may be stored in a target results database 1230. For example, the live performance operational data, from the machine incorporating the camera 1210, may be compared against the numerical results obtained running the test card/target (e.g., 100) by the same machine-associated camera. The live performance operational data may be used to calibrate the acceptance ranges, thresholds, etc. for test card measured parameters. For example, the live performance operational data may be correlated with the image quality attributes determined by the test card runs to identify what the image quality attribute targets (i.e., ranges, threshold values, etc.) should be to result in desirable, optimal, or best-possible live performance operational results. Thus, in some embodiments, the process 1200 provides for an operational calibration by using machine statistical performance data from image related parameters to associate and stratify test card performance ranges.

In some embodiments, the process 1200 may be repeated over multiple machines incorporating multiple cameras (not shown in FIG. 12), using statistical live performance as an associative property. Similar live mail performance could then be linked to, or associated with test card results ranges. This process could conversely apply to machines having poorer statistical performance, where poor live mail performance may be associated with, or correlated with, test card performance ranges.

In some embodiments, the results information may be linked to a common target results database 1230, which may be located remotely for access by multiple deployed machine/camera systems. Multiple machines (e.g., to provide statistical significance) may have their test card vs. live mail performance numbers associated with the resulting ranges determined as an output. In some embodiments, the system may include a live mail results reporting database and a camera target results analysis database. In some embodiments, the database reporting application could retrieve information from both database systems 1205, 1230 and the performance associations could be dynamically learned.

In some embodiments, the disclosed process 1200 could be applied to preventive maintenance cycles, for example, with technicians running test cards and getting database acceptance report results from uploaded test card images. In some embodiments, the process 1200 could also be applied for camera/system repair/adjustment confirmation purposes and/or for qualifying new vendor designs.

In some embodiments, the system could re-baseline machine test card values with live mail performance in the cases of new recognition/interpretation algorithm software releases.

In addition to using the reported test card individual performance results to identify and correct (e.g., manually or automatically) camera functional deficiencies such as, for example: camera to target mechanical alignment, transport or transport synchronization, illumination alignment to camera field of view, and external interferences, the comparison between the machine live mail statistical performance and the test card performance results may provide clarity regarding what specific result or subset of results of the test card performance has the highest correlation with the machine live mail statistical performance.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A test target for assessing image quality of a line scan camera, wherein the test target is structurally configured to be moved relative to the line scan camera in a transport direction, the test target comprising:
a planar test face structurally configured to extend perpendicular to an optical axis of the line scan camera during testing, the test face having a leading end portion, a trailing end portion opposite the leading end portion, a top end portion extending between the leading end portion and the trailing end portion, a bottom end portion opposite the top end portion and extending between the leading end portion and the trailing end portion;
a plurality of test portions located on the planar test face, the plurality of test portions comprising:
a lines-per-inch (LPI) test portion having a series of LPI test markers evenly spaced apart in a line extending in the transport direction, wherein the series of equally spaced-apart LPI test markers include a first LPI test marker in the leading end portion, a second LPI test marker in the trailing end portion, and one or more intermediate LPI test markers between the first LPI test marker and the second LPI test marker;
a dots-per-inch (DPI) test portion having a first DPI test marker in the top end portion and a second DPI test marker in the bottom end portion spaced apart from the first DPI test marker in a vertical direction that is perpendicular to the transport direction;
a localized DPI test portion having a first localized DPI test marker in the top end portion, a second localized DPI test marker in the bottom end portion, and an intermediate localized DPI test marker evenly spaced apart from both the first localized DPI test marker and the second localized DPI test marker in the transport direction, where the first localized DPI test marker has a first height, the second localized DPI test marker has a second height, and the intermediate localized DPI test marker has a third height, wherein the first height, the second height, and the third height are equal;
a uniformity test portion having an uninterrupted white area, with uniform grayscale value, extending from the top end portion to the bottom end portion in the vertical direction and having a width of two or more pixels;
a spatial frequency response (SFR) test portion having a first SFR test marker in the top end portion, a second SFR test marker in the bottom end portion spaced apart from the first SFR test marker in the vertical direction, and a third SFR test marker evenly spaced apart from both the first and second SFR test markers in the vertical direction; and
a signal-to-noise ratio (SNR) test portion having a first SNR white test area positioned in the top end portion, a second SNR white test area positioned in the bottom end portion, and a third SNR white test area positioned between the top end portion and the bottom end portion, wherein the first SNR white test area, the second SNR white test area, and the third SNR white test area have uniform whiteness.

2. The test target according to claim 1, wherein the first LPI test marker, the second LPI test marker, and the one or more intermediate LPI test markers are in the top end portion and are circular.

3. The test target according to claim 1, wherein each of the localized DPI test markers includes a slanted edge extending in the transport direction.

4. The test target according to claim 1, wherein each of the first, the second, and the third SFR test markers include a slanted horizontal edge and a slanted vertical edge.

5. The test target according to claim 1, further comprising an optical efficiency conversion factor (OECF) test portion including a plurality of OECF test markers each with a different grayscale value, wherein the plurality of OECF test markers are positioned in a zig zag arrangement of decrementing grayscale values.

6. The test target according to claim 5, wherein the plurality of OECF test markers have an overall grayscale value range, and wherein each OEFC test marker in a lower half of the overall grayscale value range is arranged adjacent to an OEFC test marker in an upper half of the overall grayscale value range.

7. The test target according to claim 6, wherein each OEFC test marker in the lower half of the overall grayscale value range is separated from an adjacent OEFC test marker in the upper half of the overall grayscale value range by a bar space transition.

8. The test target according to claim 1, further comprising a mini-monochrome resolution test portion including a first slanted bar-space pattern extending in the vertical direction, a second slanted bar-space pattern extending in the transport direction, a third slanted bar-space pattern extending in the vertical direction, and a fourth slanted bar-space pattern extending in the transport direction, wherein the first and second slanted bar-space patterns have a first spacing and the third and fourth bar-space patterns have a second spacing different than the first spacing.

9. The test target according to claim 1, further comprising a color test portion including a plurality of color test markers each with a different calibration color, wherein the plurality of color test markers includes a plurality of color test marker pairs that include three primary color-inverse color pairs and three half color pairs to the three primary color-inverse color pairs.

10. A computer-implemented method for assessing an image quality performance of a line scan camera based on image data from the line scan camera, the image data comprising multiple perpendicular scan lines of a test face of a test target moving relative to the line scan camera in a transport direction, wherein the test face has a leading end portion, a trailing end portion opposite the leading end portion, a top end portion extending between the leading end portion and the trailing end portion, and a bottom end portion opposite the top end portion and extending between the leading end portion and the trailing end portion, the method comprising:
determining a global lines-per-inch (LPI) value between a first LPI test marker in the leading end portion and a second LPI test marker in the trailing end portion;
determining a first segmented LPI value between the first LPI test marker and a third LPI test marker positioned between the first LPI test marker and the second LPI test marker;
determining a second segmented LPI value between the second LPI test marker and a fourth LPI test marker positioned between the third LPI test marker and the second LPI test marker;
determining a third segmented LPI value between the third LPI test marker and a second LPI test marker;
determining a maximum difference between the global LPI, first segmented LPI value, second segmented LPI value, and third segmented LPI values;
determining a difference between the global LPI value and a target global LPI value;
providing a first alarm indicator if the difference between the global LPI value and a target global LPI value exceeds a global LPI differential threshold value;
determining a maximum LPI difference between the global LPI, the first segmented LPI value, the second segmented LPI value, and the third segmented LPI value; and
providing a second alarm indicator if the maximum LPI difference exceeds a segmented LPI differential threshold value.

11. The method according to claim 10, further comprising, based on image data from the multiple scan lines of the test face:
determining a global dots-per-inch (DPI) value between a first DPI test marker in the top end portion and a second DPI test marker in the bottom end portion; and
determining a horizontal distortion value defined as a ratio between the global LPI value and the global DPI value; and
providing a third alarm indicator if the horizontal distortion value exceeds a horizontal distortion threshold value.

12. The method according to claim 10, further comprising, based on image data from the multiple scan lines of the test face:
determining a first localized DPI value of a first localized DPI test marker in the top end portion;
determining a second localized DPI value of a second localized DPI test marker in the bottom end portion;
determining a third localized DPI value of an intermediate localized DPI test marker located between the first localized DPI test marker and the second localized DPI test marker,
determining an DPI end balance value defined as a ratio of the first localized DPI value to the second localized DPI value;
determining a vertical distortion value defined as a ratio of an average of the first localized DPI and the second localized DPI to the third localized DPI;
providing a fourth alarm indicator if the DPI end balance value is less than a DPI end balance threshold value; and
providing a fifth alarm indicator if the vertical distortion value exceeds a vertical distortion threshold value.

13. The method according to claim 10, further comprising, based on image data from the multiple scan lines of the test face:
determining an average grayscale value of a first set vertical pixel location of three or more consecutive scan lines of the multiple scan lines in a uniformity test white area;
determining an average grayscale value of a second set vertical pixel location of the three or more consecutive scan lines of the multiple scan lines in the uniformity test white area;
determining an average grayscale value of a third set vertical pixel location of the three or more consecutive scan lines of the multiple scan lines in the uniformity test white area;
determining a uniformity value indicative of the difference in the average grayscale values of the first, the second, and the third set vertical pixel location; and
providing a sixth alarm indicator if the uniformity value is less than a uniformity threshold value.

14. The method according to claim 10, further comprising, based on image data from the multiple scan lines of the test face:
determining a first vertical spatial frequency response at 0.5 cycles per pixel based on a first SFR test marker in the top end portion, a second vertical SFR at 0.5 cycles per pixel based on a second SFR test marker in the bottom end portion, and a third vertical SFR at 0.5 cycles per pixel based on a third SFR test marker in a central portion of the test face;
determining a first vertical SFR difference between the first vertical SFR at 0.5 cycles per pixel and the second vertical SFR at 0.5 cycles per pixel, determining a second vertical SFR difference between the third vertical SFR at 0.5 cycles per pixel and one of the first vertical SFR at 0.5 cycles per pixel, the second vertical SFR at 0.5 cycles per pixel or an average of the first and second vertical SFR at 0.5 cycles per pixel; and
providing a seventh alarm indicator if the first vertical SFR difference or the second vertical SFR difference exceeds a vertical SFR difference threshold value.

15. The method according to claim 10, further comprising, based on image data from the multiple scan lines of the test face:
determining a first horizontal SFR at 0.5 cycles per pixel based on a first SFR test marker, a second horizontal SFR at 0.5 cycles per pixel based on a second SFR test marker, and a third horizontal SFR at 0.5 cycles per pixel based on a third SFR test marker;
determining a first horizontal SFR difference between the first horizontal SFR at 0.5 cycles per pixel and the second horizontal SFR at 0.5 cycles per pixel and determining a second horizontal SFR difference between the third horizontal SFR at 0.5 cycles per pixel and one of the first horizontal SFR at 0.5 cycles per pixel, the second horizontal SFR at 0.5 cycles per pixel or an average of the first and second horizontal SFR at 0.5 cycles per pixel; and
providing an eighth alarm indicator if the first horizontal SFR difference or the second horizontal SFR difference exceeds a horizontal SFR difference threshold value.

16. The method according to claim 10, further comprising, based on image data from the multiple scan lines of the test face:
determining a first vertical cycles-per-pixel (CPP) interval at 50% SFR (SFR-50) based on a first SFR test marker in the top end portion, a second vertical CPP at SFR-50 based on a second SFR test marker in the bottom end portion, and a third vertical CPP at SFR-50 based on a third SFR test marker in a central portion of the test face;
determining a first vertical CPP interval difference between the first vertical CPP at SFR-50 and the second vertical CPP at SFR-50, determining a second vertical CPP interval difference between the third vertical CPP at SFR-50 and one of the first vertical CPP at SFR-50, the second vertical CPP at SFR-50 or an average of the first and second vertical CPP at SFR-50; and
providing a ninth alarm indicator if the first vertical CPP interval difference or the second vertical CPP interval difference exceeds a vertical CPP interval difference threshold value.

17. The method according to claim 10, further comprising, based on image data from the multiple scan lines of the test face:
determining a first horizontal cycles-per-pixel (CPP) interval at 50% SFR (SFR-50) based on a first SFR test marker in the top end portion, a second horizontal CPP at SFR-50 based on a second SFR test marker in the bottom end portion, and a third horizontal CPP at SFR-50 based on a third SFR test marker in a central portion of the test face;
determining a first horizontal CPP interval difference between the first horizontal CPP at SFR-50 and the second horizontal CPP at SFR-50, determining a second horizontal CPP interval difference between the third horizontal CPP at SFR-50 and one of the first horizontal CPP at SFR-50, the second horizontal CPP at SFR-50 or an average of the first and second horizontal CPP at SFR-50; and
providing a tenth alarm indicator if the first horizontal CPP interval difference or the second horizontal CPP interval difference exceeds a horizontal CPP interval difference threshold value.

18. A method for assessing an image quality performance of a line scan camera, comprising:
imaging, with a line scan camera, a test face of a test target moving relative to the line scan camera in a transport direction, wherein imaging includes capturing multiple scan lines of the test face perpendicular to the transport direction, wherein the test face has a leading end portion, a trailing end portion opposite the leading end portion, a top end portion extending between the leading end portion and the trailing end portion, a bottom end portion opposite the top end portion and extending between the leading end portion and the trailing end portion; and
determining, based on image data from the multiple scan lines of the test face, one or more quality attributes indicative of the imaging performance of the line scan camera.

19. The method according to claim 18, further comprising collecting image data from the line scan camera during live operational runs and determining one or more operational performance metrics indicative the imaging performance during the live runs.

20. The method according to claim 19, further comprising providing an operational calibration by correlating the one or more operational performance metrics with one or more quality attributes based on image data from the multiple scan lines of the test face.
